(19) United States
(12) Patent Application Publication
(10) Pub. No.: US 2026/0289279 A1
(43) Pub. Date: Sep. 24, 2026

(54) ITERATIVE INSTRUCTION INDUCTION FOR TEXT-TO-LOGICAL FORM PROMPT

(71) Applicant: Oracle International Corporation, Redwood Shores, CA (US)

(72) Inventors: Duy Vu, Melbourne (AU); Dai Quoc Nguyen, Raceview (AU); Thanh Tien Vu, Herston (AU); Yakupitiyage Don Thanuja Samodhye Dharmasiri, Melbourne (AU)

(73) Assignee: Oracle International Corporation, Redwood Shores, CA (US)

(21) Appl. No.: 19/570,428

(22) Filed: Mar. 18, 2026

Related U.S. Application Data
(60) Provisional application No. 63/773,597, filed on Mar. 18, 2025.

(51) Int. Cl. G06N 3/0475; G06F 16/2452; G06F 40/58

(52) U.S. Cl. CPC G06N 3/0475; G06F 16/24522; G06F 40/58

(57) ABSTRACT

Disclosed are approaches for automatically generating and refining instructions for converting natural language questions to a logical form such as structured query language (SQL). An initial evaluation using a baseline prompt identifies errors in generated SQL queries. These errors are clustered to identify common failure patterns. For a selected error cluster, candidate instructions are generated to address the pattern. The candidate instructions are then validated to confirm they improve accuracy for the error cluster without degrading overall performance across a training set. Upon successful validation, the instructions are incorporated. This process of identifying error clusters, generating instructions, and validating them is repeated iteratively to progressively enhance the instruction set. The resulting instructions may also be automatically compressed to reduce length while maintaining performance, thereby improving operational efficiency.

### CROSS-REFERENCE TO RELATED APPLICATION

The present application is a non-provisional application of and claims the benefit and priority under 35 U.S.C. 119 (e) of U.S. Provisional Application No. 63/773,597, filed on Mar. 18, 2025, the entire contents of which is incorporated herein by reference in its entirety for all purposes.

### FIELD

The present disclosure relates generally to converting natural language to a logical form, and more particularly, to techniques for generating instructions for Text-to-Logical Form (e.g., NL2SQL) prompts.

### BACKGROUND

The advent of database management systems has revolutionized the way large datasets are stored, managed, and queried. Traditional databases, such as relational databases, have become the backbone of many applications across various industries. These databases are structured to store data in tables, allowing for the organization and retrieval of information in a systematic manner. The efficiency and reliability of databases have made them indispensable in fields such as finance, healthcare, and e-commerce, where large volumes of data need to be managed with precision and speed.

Structured Query Language (SQL) has been the primary tool for interacting with relational databases. SQL allows users to perform a wide range of operations, including data insertion, updates, deletions, and complex queries to retrieve specific information. The power and flexibility of SQL have made it the standard language for database management. However, the effective use of SQL requires a certain level of expertise, as constructing accurate and efficient queries can be complex and challenging for users who are not well-versed in the language.

In recent years, there has been a significant development in the field of databases with the emergence of text-to-SQL systems. These systems are designed to bridge the gap between natural language and SQL, enabling users to interact with databases using plain, conversational language. Text-to-SQL systems leverage advanced natural language processing (NLP) techniques and machine learning algorithms to translate user queries expressed in natural language into SQL commands. This innovation has the potential to democratize access to databases, allowing users without specialized SQL knowledge to efficiently retrieve and manipulate data.

The integration of text-to-SQL systems into database management represents a significant advancement in making databases more accessible and user-friendly. By simplifying the interaction with databases, these systems can enhance productivity and reduce the learning curve associated with database management. As businesses and organizations continue to accumulate and rely on large datasets, the ability to easily and accurately query databases using natural language will become increasingly valuable. This disclosure presents techniques for the implementation and improvement of text-to-query language technologies including SQL, ensuring that the benefits of these advancements can be realized across various domains.

### BRIEF SUMMARY

Artificial intelligence techniques are disclosed herein (e.g., a computer implemented method, a system, non-transitory computer-readable medium storing code or instructions executable by one or more processors) for generating instructions for Text-to-Logical Form (e.g., SQL) prompts.

In various embodiments, a computer-implemented method includes identifying a subset of rejected examples from a set of training examples, wherein the subset of rejected examples include logical form queries that fail one or more tests; grouping the subset of rejected examples into one or more groups of rejected examples based on similarity between the subset of rejected examples; augmenting a baseline prompt to include instructions associated with errors in at least some rejected examples in the subset of rejected examples, wherein the augmenting is an iterative process comprising: generating, by a first generative model, instructions for a group of the one or more groups of rejected examples based on a pattern of error identified for the group of rejected examples, evaluating performance of a second generative model using the baseline prompt updated to include the instructions and the logical form query generated for each example of: the set of training examples, the subset of rejected examples, or the group of rejected examples, and in response to the performance meeting or exceeding a threshold, updating the baseline prompt to include the instructions for the group of rejected examples, identifying another subset of rejected examples from the set of training examples or the subset of rejected examples, grouping the another subset of rejected examples into another one or more groups of rejected examples, and repeating the iterative process using the baseline prompt augmented with the instructions from one or more prior cycles of the iterative process and the another one or more groups of rejected examples; and providing the augmented baseline prompt.

In some embodiments, the computer-implemented method further comprises: accessing the set of training examples, wherein each example of the set of training examples includes a natural language utterance; generating, by the second generative model based on the baseline prompt, a logical form query that corresponds to the natural language utterance for each example of the set of training examples; and evaluating performance of the second generative model using the logical form query generated for each example of the set of training examples, wherein the identifying of the subset of rejected examples is performed based on the evaluating, and wherein the one or more tests include determining: (i) the logical form queries are not equivalent to corresponding gold queries, (ii) the logical form queries are not able to be executed on a database, (iii) query results from executing the logical form queries on the database are not equivalent to gold query results from executing the corresponding gold queries on the database, or (iv) any combination thereof.

In some embodiments, the iterative process further comprises in response to the performance not meeting or exceeding the threshold, revising the instructions for the group of rejected examples or the another group of rejected examples until the performance meets or exceeds the threshold using the revised instructions or a predetermined number of iterations is met.

In some embodiments, grouping the subset of rejected examples comprises grouping based on a similarity between embedding vectors for each example of the subset of rejected examples.

In some embodiments, the computer-implemented method further comprises: receiving, from a client device, a production natural language utterance, wherein the production natural language utterance includes a data request associated with a production database; generating a prompt based on the production natural language utterance and the updated baseline prompt which includes the instructions; generating, by a production generative model or the second generative model, a logical form query associated with the production natural language utterance; executing the logical form query associated with the production natural language utterance on the production database to obtain a production query result; and providing the production query result to the client device.

In some embodiments, the computer-implemented method further comprises: generating a prompt comprising the instructions after the iterative process has completed or after one or more cycles of the iterative process has completed; generating, by a third generative model, compressed instructions based on the instruction; and updating the baseline prompt to include the compressed instructions.

In some embodiments, the evaluating comprises: determining, by one or more generative models, equivalence between the logical form query and a gold logical form query for each example of: the set of training examples, the subset of rejected examples, or the group of rejected examples; or executing the logical form query and a gold logical form query for each example of: the set of training examples, the subset of rejected examples, or the group of rejected examples on a database, and determining, for each example, whether the logical form query is not executable on the database or when the logical form query is executable on the database, equivalence between a query result obtained via executing the logical form query and a gold query result obtained via executing the gold logical form query, wherein the evaluating is performed using bootstrap sampling such that the logical form query is randomly selected from the examples for the evaluating.

Some embodiments include a system that includes one or more processors; and one or more computer-readable media storing instructions which, when executed by the one or more processors, cause the system to perform part or all of the operations and/or methods disclosed herein.

Some embodiments include one or more non-transitory computer-readable media storing instructions which, when executed by one or more processors, cause a system to perform part or all of the operations and/or methods disclosed herein.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

The present disclosure will be better understood in view of the following non-limiting figures, in which:

FIG. 1 depicts a simplified diagram for an example NL2SQL tool, according to various embodiments.

FIG. 2 depicts a simplified diagram for an example generative AI SQL agent system, according to various embodiments.

FIG. 3 depicts a simplified diagram for an example generative AI SQL agent, according to various embodiments.

FIG. 4 depicts a simplified block diagram for training, testing, and producing an NL2SQL Model, according to various embodiments.

FIG. 5 depicts a simplified example flow diagram for augmenting a baseline prompt, according to various embodiments.

FIG. 6 depicts a simplified example flow diagram for augmenting a baseline prompt, according to various embodiments.

FIG. 7 depicts a simplified example flow diagram for augmenting a baseline prompt, according to various embodiments.

FIG. 8 depicts a simplified diagram for an example augmented baseline prompt, according to various embodiments.

FIG. 9 depicts a simplified diagram for an example NL2SQL prompt generation with an augmented baseline prompt, according to various embodiments.

FIG. 10 is a flowchart illustrating an example process for augmenting a baseline prompt, according to various embodiments.

FIG. 11 is a block diagram illustrating one pattern for implementing a cloud infrastructure as a service system, according to various embodiments.

FIG. 12 is a block diagram illustrating another pattern for implementing a cloud infrastructure as a service system, according to various embodiments.

FIG. 13 is a block diagram illustrating another pattern for implementing a cloud infrastructure as a service system, according to various embodiments.

FIG. 14 is a block diagram illustrating another pattern for implementing a cloud infrastructure as a service system, according to various embodiments.

FIG. 15 is a block diagram illustrating an example computer system, according to various embodiments.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

### INTRODUCTION

In recent years, the amount of data powering different industries and their systems has been increasing exponentially. A majority of business information is stored in the form of relational databases that store, process, and retrieve data. Databases power information systems across multiple industries, for instance, consumer tech (e.g., orders, cancellations, refunds), supply chain (e.g., raw materials, stocks, vendors), healthcare (e.g., medical records), finance (e.g., financial business metrics), customer support, search engines, and much more. It is imperative for modern data-driven companies to track the real-time state of its business in order to quickly understand and diagnose any emerging issues, trends, or anomalies in the data and take immediate corrective actions. This work is usually performed manually by analysts who compose complex queries in query languages (e.g., database query languages such as declarative query languages) like SQL, PGQL, logical database queries, API query languages such as GraphQL, REST, and so forth. Composing such queries can be used to derive insightful information from data stored in multiple tables. These results are typically processed in the form of charts or graphs to enable users to quickly visualize the results and facilitate data-driven decision making.

Although common database queries (e.g., SQL queries) are often predefined and incorporated in commercial products, any new or follow-up queries still need to be manually coded by the analysts. Such static interactions between database queries and consumption of the corresponding results require time-consuming manual intervention and result in slow feedback cycles. It is vastly more efficient to have non-technical users (e.g., business leaders, doctors, or other users of the data) directly interact with the analytics tables via natural language (NL) queries that abstract away the underlying query language (e.g., SQL) code. Defining the database query requires a strong understanding of database schema and query language syntax and can quickly get overwhelming for beginners and non-technical stakeholders. Efforts to bridge this communication gap have led to the development of a new type of processing called natural language interfaces for databases (NLIDB). This natural search capability has become more popular over recent years as companies are developing deep-learning approaches for natural language to logical form (NL2LF) such as natural language to SQL (NL2SQL).

Logical form can refer to (i) programming query languages, (ii) intermediate forms, and/or (iii) programming languages. Programming query languages can include database query languages, and examples of programming query languages include, but are not limited to, SQL, PQL, GraphQL, SPARQL, and the like. Intermediate forms can refer to machine-oriented languages and/or meaning representation languages (MRLs) such as OMRL, AMRL, and the like. Examples of programming languages include, but are not limited to, Python, C++, Java, Ruby, and the like. NL2SQL seeks to transform natural language questions to SQL, allowing individuals to run unstructured queries against databases. The converted SQL could also enable digital assistants such as chatbots and others to improve their responses when the answer can be found in different databases or tables with different schemas.

NL2LF, specifically NL2SQL, transforms natural language to SQL using generative artificial intelligence models such as large language models (LLMs). An LLM is a type of artificial intelligence (AI) that is trained to understand, generate, and manipulate human language (e.g., text data) in a coherent and contextually relevant manner. LLMs have resulted in significant progress in natural language processing tasks such as text-to-code (e.g., text-to-SQL), text generation and translation, and sentiment analysis. Due to their attention mechanisms and deep neural architectures, LLMs excel at capturing nuanced language patterns and correlations in massive volumes of text data. LLMs are designed to predict the next word or token in a sequence of text by computing a probability distribution over a fixed vocabulary for the next token based on the context of the preceding tokens. The prediction is achieved through a series of self-attention mechanisms incorporated in the LLMs that assign varying degrees of importance to different parts of the input sequence that enable the LLMs to make informed predictions. LLMs generate contextually appropriate and coherent text by learning a fixed vocabulary from enormous text corpora and predicting which token included in the fixed vocabulary should be the next token in an output sequence.

In addition to at least a portion of the database schema, the main input to the Text-to-SQL model is a natural language question. For example: “tell me invoices starting with IBY7”. The main output from the Text-to-SQL model is a SQL query. For example: “SELECT *FROM accounts_payable_invoices WHERE LOWER (INVOICE_NUMBER) LIKE LOWER (‘iby7%’)”. As discussed above, the Text-to-SQL model may be based on generative models such as LLMs, e.g., prompting a LLM to generate the SQL query from schema and question inputs. The accuracy of the translation by the NL2LF model is highly dependent on the quality of the prompt provided to the generative model. The database schemas may share the same NL2SQL prompt template, and the prompt template is populated with specific information (e.g., schema description comprising relevant information about tables and columns and potential values that will help the LLM to generate the correct SQL) for a current database schema. The prompt may further include business logic and instructions such as how to check for payment paid status with the column “accounts_payable_invoices.payment_status_flag” or remind the model to check for the column “amount_paid” if the user asks for ‘amount paid’ or ‘settled amount’. This business logic and instructions section may also include generic instructions on date time format or casing to help the model generate proper SQL queries.

Conventional methods for creating these essential instructions are almost entirely manual, presenting significant technical challenges that hinder the widespread and efficient deployment of high-performance NL2SQL systems. The process of manual prompt engineering is exceptionally time-consuming and labor-intensive. It requires a developer or prompt engineer to perform a tedious, iterative cycle of creating a comprehensive set of training examples, executing queries to identify and analyze prediction errors, manually authoring new instructions to address specific error patterns, and re-running all tests to ensure the new instructions have not inadvertently introduced new errors, a phenomenon known as regression. This manual process does not scale effectively. As database schemas increase in complexity, or as an organization seeks to deploy NL2SQL capabilities across numerous distinct databases, the manual effort required for each implementation becomes a prohibitive bottleneck.

Furthermore, the quality of manually crafted instructions is highly dependent on the skill, intuition, and domain expertise of the individual developer, which can lead to inconsistent performance across different database applications. A human engineer may struggle to foresee the full impact of a new instruction on the entire set of training examples, often leading to sub-optimal prompts that fix one class of error while causing regressions in others. Manually tuned prompts are also often “brittle,” meaning they are finely tuned to a specific set of training examples and may fail when presented with slightly different questions or when the underlying database schema changes. This creates a continuous and costly maintenance burden, as prompts must be constantly revisited and updated to maintain accuracy.

An additional challenge arises from the operational costs associated with lengthy prompts. In an effort to improve accuracy, developers often add a large number of detailed instructions to the prompt. While this can fix errors, it also progressively increases the length of the prompt context provided to the LLM for every query. Longer prompts directly translate to higher computational requirements for the language model. This, in turn, leads to increased inference latency, which can negatively impact user experience, and results in significant operational costs, a factor that is particularly problematic for real-time or high-throughput applications where both speed and cost-efficiency are paramount.

To overcome these challenges and others, the present disclosure provides an iterative, and fully automated system for generating, validating, and compressing instructions for NL2SQL prompts. The disclosed system intelligently mimics and improves upon the manual human workflow, leveraging computational power to achieve a superior level of performance and efficiency. The automated process operates as a greedy instruction induction loop that continues until no further improvement can be made or a maximum number of iterations is reached. In each iteration, a current list of training errors is collected and automatically clustered into distinct groups based on semantic similarity. This may be accomplished, for example, by generating embeddings for each error's natural language question and its corresponding correct SQL query, and then applying a clustering algorithm, such as DBSCAN or Agglomerative Clustering, to group similar errors together. The system then focuses on the largest group of errors and generates a set of candidate instructions specifically tailored to address the common pattern of failure observed within that group. These new instructions are then rigorously evaluated using a bootstrapped sampling method.

The evaluation involves running the prompt, now augmented with the candidate instructions, against the training data multiple times with different random seeds to calculate an average accuracy. This statistical approach provides a reliable verification that the new instructions increase accuracy for the target error group without causing a regression in the overall accuracy of the entire training set. If the candidate instruction set meets these performance criteria, it is accepted and permanently added to the prompt's main set of instructions. Following the addition of a new instruction set, the entire process is repeated: the newly updated prompt is used to re-evaluate the full training set (or a portion thereof, e.g., those training examples not corrected in the previous iteration), generating a new and typically smaller list of training errors. This new list of errors is then clustered, and the system again attempts to generate and validate instructions for the next largest error group. This iterative refinement cycle continues, progressively enhancing the prompt's accuracy with each loop, until a predetermined stopping condition is met.

A further aspect of the disclosed system is an optional but significant process for compressing the entire set of instructions to reduce its length while ensuring performance is maintained. After new instructions have been successfully added, a compression step may be initiated. In this step, the full set of instructions can be grouped by similarity and provided to a generative model with a task to shorten or consolidate them. The newly compressed set of instructions is then used to form a new, shortened prompt. This shortened prompt is subjected to the same rigorous, bootstrapped evaluation against the full training set. The compressed instructions are only accepted if the resulting prompt maintains or improves upon the current level of accuracy, thereby ensuring that the benefits of a shorter prompt do not come at the cost of performance.

This automated system and methodology directly solve the problems inherent in conventional methods by eliminating the time-consuming and labor-intensive manual work required from developers, thereby providing a scalable and consistent process for deploying NL2SQL systems. The use of a robust, bootstrapped evaluation process programmatically ensures that new instructions provide a net positive impact across the entire training set, allowing the system to avoid the pitfalls of manual tuning and systematically converge on a highly optimized set of instructions. As demonstrated by experimental results, this automated method of generating instructions can surpass the performance of human prompt engineers by achieving a 10% to 15% absolute improvement in test accuracy. The instruction generation process itself is optimized for correctness, which may result in a comprehensive and potentially verbose set of instructions. To address the operational challenges associated with longer prompts, the disclosed system further provides for an optional but advantageous compression step. By applying this automated compression process, the system can achieve substantial reductions in the total length of the instructions, for example, in the range of 50% to 80%, as shown in the experimental data. This significant reduction in prompt length directly leads to lower inference latency and reduced computational expense for each query processed, all while maintaining the high level of accuracy achieved through the iterative generation process.

### Overview of Agents and NL2SQL Framework

An agent (also referred to as a skill, chatbot, chatterbot, talkbot, digital assistant, or the like) is a computer program that can engage in conversations with end users. The agent can generally respond to natural language messages (e.g., questions or comments) through a messaging application that uses natural language messages. Enterprises may use one or more agent systems to communicate with end users through a messaging application. The messaging application, which may also be referred to as a channel, may be an end user's preferred messaging application that they have already installed and are familiar with. Thus, the end user does not need to download or install new applications in order to chat with the agent system. The messaging application may interface with, for example, over-the-top (OTT) messaging channels (such as Facebook Messenger, WhatsApp, WeChat, Line, Kik, Telegram, Talk, Skype, Slack, or SMS); virtual private assistants (such as Amazon Alexa, Google Assistant, Apple Siri, or Microsoft Cortana, accessible through devices like Amazon Echo, Google Home, Apple HomePod, or compatible mobile devices); mobile and web app extensions that add chat capabilities to native or hybrid/responsive apps or web applications; or voice-based input (such as devices or apps that utilize Siri, Google Assistant, Alexa, Cortana, or other speech-based interfaces).

End user may interact with the agent system through a conversational interaction (sometimes referred to as a conversational user interface (UI)), similar to interactions between people. In some cases, the interaction may include the end user providing an utterance such as the query: “Please retrieve all invoices greater than ten thousand dollars for the last four years for Customer Y”, to the agent, and the agent responding with a natural language response based on translation of the user's natural language query to an SQL query and execution of the SQL query on an appropriate database.

In some embodiments, the agent system may intelligently handle end user interactions without interaction with an administrator or developer of the agent system. For example, an end user may send one or more messages to the agent system in order to achieve a desired goal. A message may include certain content, such as natural language text, audio, image, video, or another method of conveying a message. In some embodiments, the agent system may convert the content into a standardized logical form (e.g., an SQL query). The agent system may also prompt the end user for additional input parameters or request other additional information. In some embodiments, the agent system may also initiate communication with the end user, rather than passively responding to end user utterances. Described herein are various techniques for identifying an explicit or implicit invocation of an agent system and determining an input for the agent system being invoked.

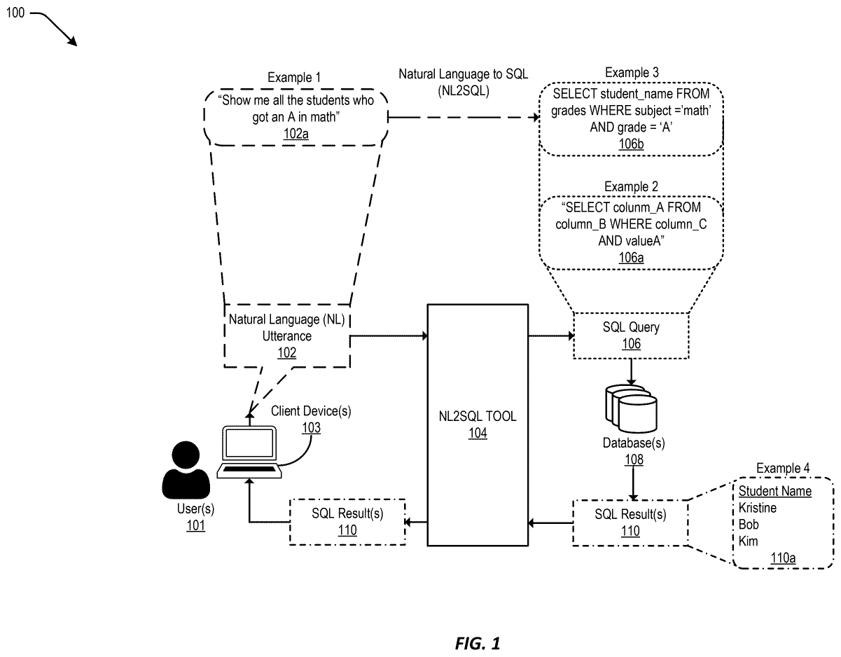

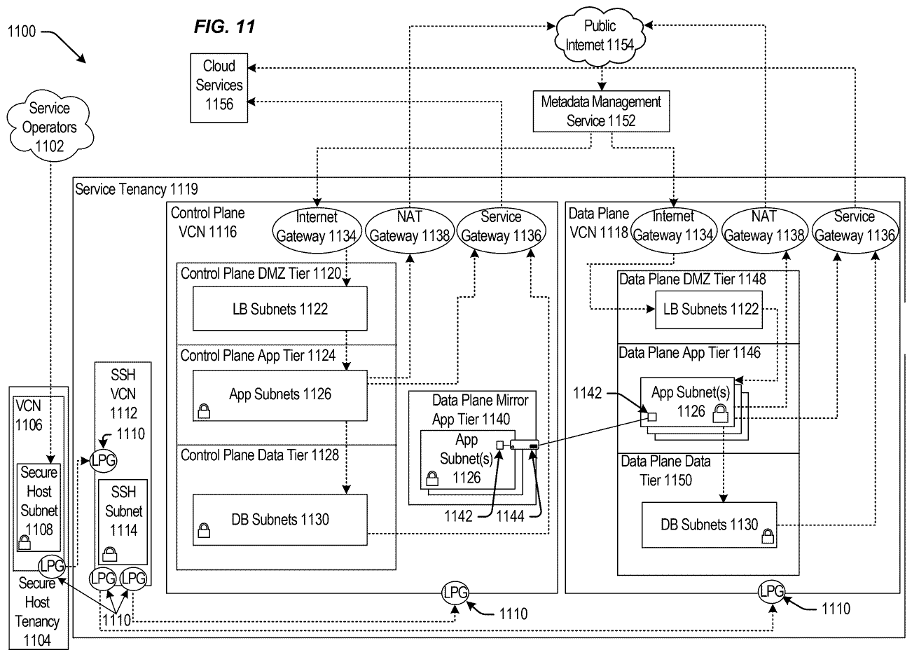

FIG. 1 depicts a simplified diagram of an environment 100 incorporating an exemplary NL2SQL tool, according to various embodiments. Environment 100 includes an NL2SQL tool 104 that enables users 101 to receive (i) a translated version of a natural language utterance 102 (e.g., a natural language query translated into a given programming language such as SQL), and/or (ii) a result of executing an action related to a natural language utterance 102 (e.g., a natural language query translated into a given programming language such as SQL, which is then executed on a database to retrieve a result for the query). As shown in FIG. 1, the NL2SQL tool 104 is configured to generate an SQL query 106 and one or more SQL query result(s) 110 based on the provided natural language utterance 102; however, other examples may implement tasks in addition to or in alternative to SQL query generation (e.g., schema checking, schema linking, sentence completion, extraction of key information, debugging, and other SQL-related tasks). The NL2SQL tool 104 can be implemented using software only, hardware only, firmware only, or any combination of hardware, software, and/or firmware. In some instances, the environment 100 is part of an Infrastructure as a Service (IaaS) cloud service (described in more detail with respect to FIGS. 11-15) and the NL2SQL tool can be implemented as part of the IaaS by leveraging the scalable computing resources and storage capabilities provided by the IaaS provider to process and manage large volumes of data and complex computations. This setup can allow the NL2SQL tool 104 to deliver real-time, responsive interactions while ensuring high availability, security, and performance scalability to meet varying demand levels. The NL2SQL tool 104 can be embodied or implemented in various physical systems or devices, such as in a computer, a mobile phone, a watch, an appliance, a vehicle, and the like. For the purposes of this example, the NL2SQL tool 104 generates and accepts queries related to SQL, but it should be understood that the techniques described herein are not limited to SQL and the NL2SQL tool 104 can be configured as any other NL2LF tool capable of generating queries and statements using other programming languages (e.g., PRQL, GraphQL, WebAssembly, Python, R, Java, N1QL, and the like).

As illustrated in FIG. 1, a user 101 provides a user input to the NL2SQL tool 104. The user input can be, or include a natural language utterance 102. The natural language utterance can be in text form, such as when the user types a sentence, a question, a text fragment, or phrase and provides it as input to the NL2SQL tool 104 via client device(s) 103. The client device(s) 103 can be configured to communicate with the NL2SQL tool 104, provide the natural language utterance 102 to the NL2SQL tool 104 and receive outputs from the NL2SQL tool 104. In some implementations, the natural language utterance 102 can be in speech form, which may be converted to text form and provided to the NL2SQL tool 104. As an example, a natural language utterance 102 such as 102a “Show me all the students who got an A in math” can be spoken by the user 101 and the NL2SQL tool 104 may be configured as a standalone tool, as a plug-in, or make use of another audio-to-text translator, configured to translate the audio into text for further processing.

The NL2SQL tool 104 may be, or may make use of, one or more generative artificial intelligence models such as LLMs configured to generate an SQL query 106 (e.g., 106a or 106b) based on the natural language utterance 102. The NL2SQL tool 104 may receive a prompt including the natural language utterance 102 to generate an SQL query 106 that is relevant to the preferences of user 101. In some implementations, the user 101 and/or client device 103 generate a prompt including the natural language utterance 102 before providing the prompt to the NL2SQL tool 104. In other implementations, the NL2SQL tool 104 receives the natural language utterance 102 and generates the prompt itself, e.g., by populating slots of a prompt template, before providing the prompt to a trained generative artificial intelligence model.

The NL2SQL tool 104 converts the natural language utterance 102 (as in example 1 depicted in FIG. 1) to the SQL query 106. The NL2SQL tool 104 may consider schema information corresponding to one or more databases 108 to generate the SQL query 106. The SQL query 106 (as in examples 2 or 3 depicted in FIG. 1) may be executed on database(s) 108 to obtain an SQL result 110. As a non-limiting example, SQL result 110 can be a list of students who got an A in math based on a generated SQL query 106. The SQL result(s) 110 can be provided back to the user 101 by the NL2SQL tool 104. In some instances, the SQL result(s) 110 are reported back to the user 101 as raw output. In other instances, the SQL result(s) 110 are reported back to the user 101 as part of a natural language response (e.g., a summary) generated by the one or more generative artificial intelligence models in response to the natural language utterance 102. In other instances, the SQL result(s) 110 are reported back to the user 101 as part of a natural language response (e.g., a summary) generated by the one or more generative artificial intelligence models and/or with a visualization (e.g., a bar chart, pie chart, table, or the like) generated by one or more generative artificial intelligence models and/or analytic subsystems in response to the natural language utterance 102. The user 101 may receive the SQL result(s) 110 through the client device(s) 103. Additionally or alternatively, the NL2SQL tool 104 may provide the SQL query 106 to the user(s) via other means such as an email communication, SMS message, or other types of notification receivable on one or more other computing devices. In some implementations, the SQL query 106 is provided to the user(s) in addition to or instead of running the SQL query 106 on the database(s) 108 to obtain SQL result(s) 110 (e.g., as part of a feedback request to validate the SQL query 106).

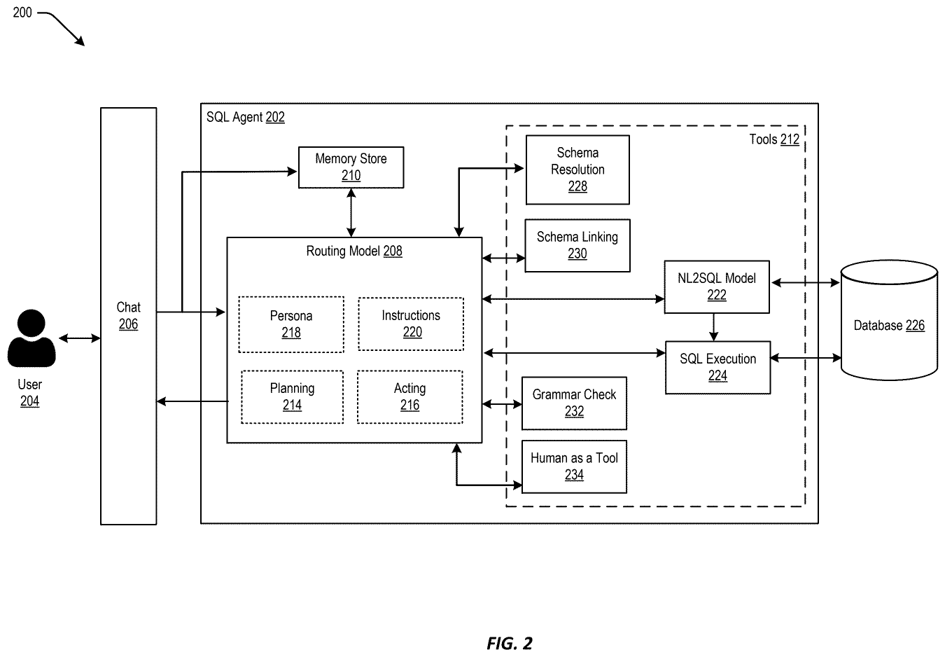

FIG. 2 is a simplified block diagram of an SQL agent system 200 according to certain embodiments. SQL agent system 200 is a computing system that can be implemented in software only, hardware only, firmware only, or any combination of hardware, software, and/or firmware. The SQL agent system 200 can convert natural language questions into SQL to help users complete their data related tasks by leveraging the power of generative artificial intelligence such as LLMs. In addition to their language capabilities (e.g., sentence completion, summarization, extraction of key information from text passages), generative artificial intelligence models can generate SQL statements. The purpose of the SQL agent system 200 is to enable users to interact with their databases with the least amount of effort. This may include the SQL agent system 200 interpreting user requests in natural language, reviewing database schema, implementing schema linking (i.e. identifying names of tables and columns in natural language questions), generating SQL queries and even executing the SQL statements. In certain embodiments, the SQL agent system 200 can be used to implement one or more tools related to SQL generation, execution, and/or review (e.g., NL2SQL tool 104 as described with respect to FIG. 1). The SQL agent system 200 can include an SQL agent 202 capable of converting a natural language question into an SQL query.

A user 204 can participate in a chat 206 (also described herein as a conversation or an interaction) with the SQL agent 202. The user 204 may interact with the chat 206 via a user interface such as a graphical user interface or conversational user interface. As an example, the user 204 may provide input to the SQL agent 202 via a user interface element such as a chat window. The chat 206 can include one or more inputs from the user 204 and one or more responses from the SQL agent 202. The chat 206 may correspond to one or more chat sessions between the user 204 and the SQL agent 202. During the chat 206, the user 204 provides a natural language utterance that can be processed by the SQL agent 202. The natural language utterance can include a question related to a database or SQL generation.

One or more user inputs provided by the user 204 via the chat 206 are provided to the SQL agent 202. Included in the SQL agent 202 are a routing model 208, a memory store 210 and tools 212. The routing model 208 and memory store 210 receive user inputs such as natural language utterances from the chat 206. The memory store 210 can store a chat history for the user 204 and contextual information related to the user 204, the chat 206, and/or other pieces of information relevant to the NL2SQL operations such as in-context examples, APIs, external knowledge, and the like. The tools 212 can include functions, APIs, and trained machine learning models that can be used by the SQL agent 202 to interact with external systems (e.g., database 226, external knowledge bases) and/or generate SQL statements.

The routing model 208 may be or may make use of one or more generative artificial intelligence models such as LLMs. The routing model 208 can include a planning 214 component and an acting 216 component (i.e., trained task). Planning 214 includes generating a plan that comprises a sequence of steps for execution (acting 216), which includes executing the steps in a generated plan using one or more tools 212. In some examples, the routing model 208 may retrieve contextual information related to the user 204 and/or chat 206 from the memory store 210 during planning 214 to improve plan generation. Planning 214 may further include determining a new plan based on a result produced by acting 216 and the execution of a previous plan.

One or more tools 212 supported by the SQL agent 202 may be LLM-based tools configured to receive a prompt and generate a result based at least in part on the prompt. As an example, the tools 212 can include an LLM-based NL2SQL model 222 that generates an SQL statement based on a prompt including a natural language utterance provided by the user 204 (e.g., as described in FIG. 1). In some instances, the routing model 208 can generate a prompt based on a natural language utterance received from the user 204. In some examples, steps for generating a prompt can be included in a plan generated by planning 214 and the prompt may be generated by acting 216. A prompt can include a persona 218 and instructions 220. The persona 218 can be selected from a set of available personas (see Table 1 for a non-limiting list of exemplary personas). Including the persona 218 in a prompt for an LLM may improve the accuracy of generated responses and customize responses generated by an LLM to the needs of the user 204. In some examples, planning 214 may select a tool from the tools 212 based on the persona 218.

TABLE 1

| Example Persona | Example Description |
|---|---|
| Junior Developer | A user having limited to no experience in writing SQL |
| | queries who requires assistance in writing and |
| | optimizing SQL queries. |
| Expert Developer | A user with several years of experience writing SQL |
| | queries. |
| Business Analyst | A user with strong context about the needs of a |
| | company and who wants quick data insights without |
| | deep SQL knowledge. |
| Data Scientist | A user focused on extracting and analyzing data |
| | efficiently. |

Instructions 220 describe the knowledge bases and tools available to the SQL agent 202. Instructions 220 can be included in a prompt for LLM-based tools and may guide a tool to generate a response relevant to the preferences of the user 204. Additionally, or alternatively, the prompt can include a table schema, description of columns in the table schema, context, in-context examples, additional instructions, a user question, or any combination thereof. In some examples, context may include contextual information related to the user 204 and/or chat 206 history and may be retrieved from the memory store 210 by the routing model 208. The prompt may further include database schema information corresponding to a database 226.

The routing model 208 may provide the generated prompt to a tool from the tools 212 selected by planning 214. As an example, the NL2SQL model 222 receives a prompt provided by the routing model 208 and generates an SQL query based on the prompt. The NL2SQL model 222 can be trained to convert a natural language question into an SQL query to help the user 204 complete data related tasks. In some examples, the SQL query generated by the NL2SQL model 222 is returned to the user 204 via the chat 206. Additionally, or alternatively, the generated SQL query is provided to an SQL execution 224 tool that is configured to execute SQL queries on the database 226. SQL execution 224 may receive an SQL result from the database 226 and provide the SQL result to the routing model 208. The routing model 208 may provide the SQL result to the user 204 via the chat 206. In some implementations, the routing model 208 may identify an error in the SQL result or determine the SQL query and/or result does not correspond to user 204 needs and generate a new plan using planning 214 to correct the error or generate a new SQL query.

Additional examples of tools include, but are not limited to, schema resolution 228, schema linking 230, grammar check 232, and human as a tool 234. Schema resolution 228 may be configured to check for and/or fix any errors within an SQL statement. The SQL agent 202 may use schema resolution 228 after an SQL query is generated by the NL2SQL model 222. Schema linking 230 may be configured to identify proper references to schema values (e.g., tables, columns, condition values) based on schema information and query patterns. Schema linking 230 can include content-based schema linking for mapping values, and name-based schema linking for mapping table and column names for SQL generation. For large schemas, retrieval augmented generation (RAG)-based schema linking may be implemented to retrieve a relevant subset of the schema. Schemas can be stored in a knowledge base (e.g., memory store 210) and relevant schema information can be retrieved based on a natural language query provided by the user 204. In some implementations, the knowledge base includes external data stores and schema linking 230 can include performing a web search to identify relevant schema. The SQL agent 202 may be unable to resolve ambiguities during schema linking 230. In such examples, the SQL agent 202 can ask the user 204 clarifying questions to resolve the ambiguities and/or acquire missing information to resolve the ambiguities.

Also included in the tools 212 is a grammar check 232 that can review grammar of generated statements. Tools 212 can also include human as a tool 234. The SQL agent 202 may seek human input for clarification and disambiguation. Human as a tool 234 may be used to supplement one or more additional tools of the set of tools 212 with human input or intervention. Human as a tool 234 can include asking the user 204 or another user, such as a developer, for information to correct previous generations.

The SQL agent 202 may use a single tool or a combination of tools 212 to generate a response to the user 204. The routing model 208 can select a tool and/or generate a prompt for the selected tool based on a natural language utterance received via the chat 206. The routing model 208 receives an output from the selected tool based on the prompt and/or context provided to the selected tool. In some implementations, the output generated by the selected tool is provided to the user 204 via the chat 206 as received by the routing model 208 (i.e., without additional modifications to the output).

In some implementations, the routing model 208 responds to the user 204 who provided the original query as part of a two-way conversation (e.g., via chat 206). The natural language response may include a natural language component (e.g., answers to questions, information, etc.) and/or a logical form component (e.g., an SQL query). In some embodiments, the routing model 208 may generate a natural language response containing the output generated by the selected tool. The routing model 208 may be configured to generate the natural language response and/or may use a response generation tool to generate the natural language response. The natural language response can be provided to the user 204 via the chat 206. In some implementations, the SQL agent 202 may provide a visualization of the generated output through a plot, table, graph, and the like, via the chat 206. As a particular example, the SQL agent 202 can use the schema linking 230 tool to identify names of tables and columns in a natural language utterance (which is an example of NL utterance 102 with respect to FIG. 1) provided by the user 204 and then generate an SQL query using the NL2SQL model 222 based on the identified table and column names. The SQL query may be provided to the user 204 via the chat 206 as generated by the NL2SQL model 222. In some implementations, the routing model 208 may generate a natural language response containing the SQL query and provide the natural language response to the user 204 via the chat 206.

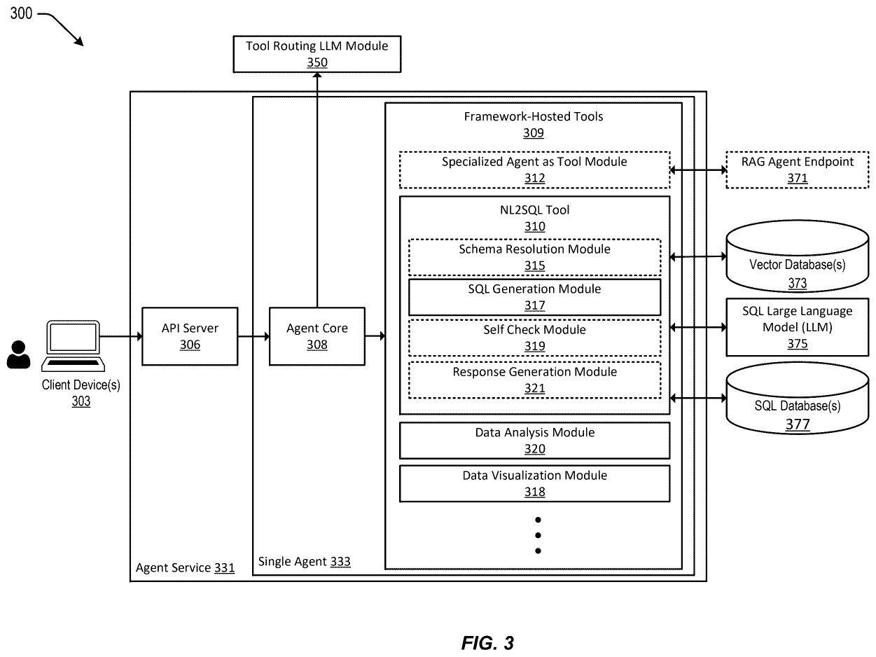

FIG. 3 depicts a simplified diagram 300 for an example generative AI SQL agent, according to various embodiments. As discussed in regard to FIGS. 1 and 2, user(s) (e.g., users 101 or 204) may use client device(s) 303 to submit a NL utterance and/or question to an agent service 331 by way of an API server 306. The API server 306 may be a software, hardware, and/or firmware component that enables one or more applications (e.g., cloud applications) to communicate as an intermediary between the client device(s) 303 and the agents. The API server 306 may identify a specific agent (e.g., single agent 333), or multiple agents, to handle the instance (e.g., by agent specialty or user preference) and select an agent core 308. The agent core 308 may be configured with pass-through routing or, if additional tools are included in the agent, a specific routing (e.g., ReAct routing) may be implemented. The agent core 308 may handle multi-step (or iterated) SQL resolution, generation, and/or execution. By way of a non-limiting example, in analytical use cases using unique software packages (e.g., Oracle™ Analytics Cloud (OAC), Tableau™, etc.), a single analytical dashboard may generate multiple SQL queries using output from previous inputs (e.g., by way of Churn analysis, Funnel analysis, cohort analysis, etc.). The agent core 308 may access a tool routing LLM module 350 in order to identify, select, utilize, and/or train one or more LLM(s) that may suitably apply to the utterance received from the client device(s) 303.

The agent core 308 may include one or more framework-hosted tools 309 for addressing various functions. For example, the framework-hosted tools 309 may include a specialized agent as tool module 312 which may be in communication with a retrieval-augmented generation (RAG) endpoint 371. The RAG endpoint 371 may improve the efficacy of one or more LLMs by suitably leveraging various sources of data. For example, retrieving data/documents relevant to the utterance (e.g., question, statement, task, etc.) and providing them as context for the LLM as either labeled or unlabeled data. The RAG endpoint 371 may provide support to the agent core and maintain up-to-date information based at least in part on other trained LLMs and/or agent cores (not depicted), and/or access domain-specific knowledge.

Included in the framework-hosted tools 309 is an NL2SQL tool 310, which is an example of the NL2SQL model 222 with respect to FIG. 2. The NL2SQL tool 310 includes, without limitation, modules 315, 317, 319, and 321. Schema resolution module 315 may function to receive input from the client device(s) 303 requesting the NL2SQL tool 310 check one or more schemas for any errors (e.g., syntax errors, semantic errors, etc.) and fix the errors (or recommend a fix). The agent core 308 may provide explanations to the client device(s) 303 about each fix performed. The explanations may be provided in natural language. In some examples, the NL2SQL tool 310 may attempt to automatically resolve the errors if possible and ask clarification questions (e.g., as output to the client device(s) 303) where suitably needed. If the error cannot be resolved, the error may be displayed to the user(s). As an example, the different types of errors that an agent core 308 (which is an example component of SQL agent 202 with respect to FIG. 2) may return can include syntax errors and semantic errors. The schema resolution module 315 may reference one or more vector database(s) 373 to obtain and/or store schema.

Also included in the NL2SQL tool 310 is an SQL generation module 317. The SQL generation module 317 may take the utterance received from the client device(s) 303 and construct an SQL query. To do this, the NL2SQL tool 310 may access one or more generative artificial intelligence models such as LLMs (e.g., SQL LLM 375) that may have been trained on generating SQL queries. An LLM may receive the utterance from the NL2SQL tool 310 and may translate the utterance into a relevant SQL query. The SQL generation module 317 may then pass the received SQL query from the LLM to one or more additional modules. For example, the SQL generation module 317 may pass the SQL query returned from the LLM to a response generation module 321. The response generation module 321 may append the SQL query (optionally along with information related to the utterance) and return the SQL query to the client device(s) 303. In addition, or alternatively, the response generation module 321 may pass the SQL query to one or more SQL database(s) 377 to retrieve information related to the utterance. The NL2SQL tool 310 may utilize a self-check module 319, which may function with any one or more of the other modules. The self-check module 319 may automatically try to resolve errors associated with the SQL query and/or LLM prompt containing the utterance. The self-check module 319 may ask clarifying questions to the client device(s) 303 and/or the LLM to resolve the errors.

The framework-hosted tools 309 include data analysis module 320 and a data visualization module 318. Each of 320 and 318 may function with any of the modules of the framework-hosted tools 309 in order to analyze and display the various analytics. The analytics may include analysis of schema, SQL queries, LLM accuracy, recommendations, or suitable equivalents.

### Training, Testing, and Deployment of a NL2SQL Model

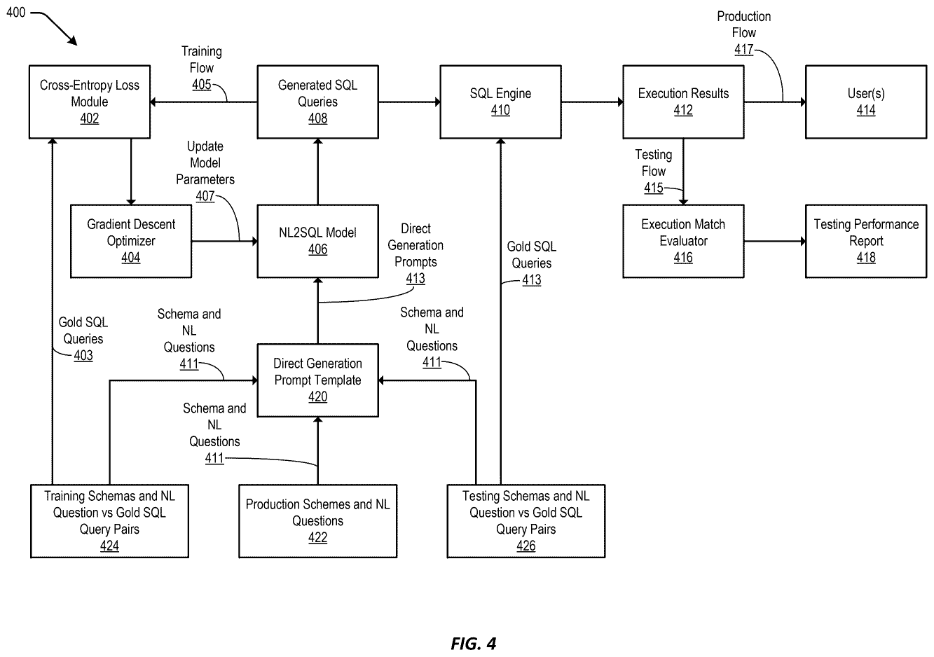

FIG. 4 depicts a simplified block diagram 400 for training, testing, and deployment or production of an NL2SQL Model, according to various embodiments. This simplified overview of training, testing, and inference depicts flows for a NL2SQL direct generation model (however it should be understood that similar steps could be implemented for a generation model that translates to an intermediate database query language which can be used to generate a query in a specific system query language or other for a generation model that translates to another programming language such as PRQL, GraphQL, WebAssembly, Python, R, Java, N1QL, and the like). A NL2SQL model is powered by a machine learning model (e.g., an LLM) configured to convert a NL utterance (e.g., a query posed by a user using an agent) into a logical form, for example, an intermediate database query language such as OMRL or a system query language format, such as SQL or PGQL. If an intermediate database query language format is used then the intermediate database query language can be used to generate a query in a specific system query language (e.g., SQL), which can then be executed for querying a system such as a database to obtain an answer to the user's utterance. If a system query language format is used, then the system query language can be directly executed for querying a system such as a database to obtain an answer to the user's utterance.

One goal of the NL2SQL model is to allow end users to interact with their systems, (e.g., SQL databases) through natural language rather than program specific language queries such as SQL queries. Using a NL2SQL service, users such as business analysts can extract information from their systems without thorough knowledge of a specific programming language and system schemas. The NL2SQL model is an LLM, which is an advanced type of artificial intelligence model designed to understand and generate human language. These models are trained on vast amounts of text data and leverage deep learning techniques to perform a variety of natural language processing tasks, such as text generation, translation, summarization, and answering questions. In the description below, the LLM (NL2SQL model) is designed and trained to convert natural language queries into SQL queries. This involves understanding the semantics of the natural language input, mapping it to the corresponding database schema, and generating a syntactically and semantically correct SQL query that can retrieve the desired information from the database. However, it should be understood that similar techniques could be implemented for other programming languages including other system query languages such as PGQL and/or other intermediate logical forms such as MRL or OMRL.

The input to the Natural Language-to-SQL (NL2SQL) model is a natural language question.

```
For example:
  “Get me the list of employees from Australia.”
The main output from the NL2SQL model is an SQL query.
For example:
  SELECT employee_id, employee_name FROM Employee WHERE country
  =″Australia″.
Another important input to the NL2SQL model 406 is the database schema that helps
the model to identify relevant tables and columns in the SQL output construction.
For example:
  CREATE TABLE Employee (
  employee_id TEXT(12) NOT NULL,
  employee_name TEXT(100) NOT NULL,
  birth_date DATE NOT NULL,
  hire_date DATE NOT NULL,
  country TEXT(100),
  ...
  )
  CREATE TABLE JobTitle (
  ...
  )
  ...
```

Described herein is a pre-trained NL2SQL model developed based on instruction fine-tuning of LLMs to provide this NL2SQL direct generation capability, e.g., the mapping of (Database Schema, NL Question)→SQL Query. Below is the summary of how the NL2SQL direct generation capability is implemented via instruction fine-tuning.

Data to train a NL2SQL model includes multiple database schemas defined as SQL CREATE TABLE statements:

```
  Table names
  Column names and types
  Primary and foreign keys
  Other constraints
```

One Database Schema Example:

```
CREATE TABLE aircraft (
  aid NUMERIC(9, 0),
  name TEXT(30),
  distance NUMERIC(6, 0),
  PRIMARY KEY (aid)
)
CREATE TABLE employee (
  eid NUMERIC(9, 0),
  name TEXT(30),
  salary NUMERIC(10, 2),
  PRIMARY KEY (eid)
)
CREATE TABLE certificate (
  eid NUMERIC(9, 0), aid NUMERIC(9, 0), PRIMARY KEY (eid, aid), FOREIGN
KEY(aid) REFERENCES aircraft (aid), FOREIGN KEY(eid) REFERENCES employee
(eid))
CREATE TABLE flight (
  flno NUMERIC(4, 0),
  origin TEXT(20),
  destination TEXT(20),
  distance NUMERIC(6, 0),
  departure_date DATE,
  arrival_date DATE,
  price NUMERIC(7, 2),
  aid NUMERIC(9, 0),
  PRIMARY KEY (flno),
  FOREIGN KEY(aid) REFERENCES aircraft (aid)
)
```

Each database schema can be associated with multiple pairs of natural language questions and corresponding SQL queries.

Example of NL Question and corresponding SQL Query:
NL Question: “What is the name of the employee with salary greater than 100000 and with the most certificates to fly planes more than 5000?”
SQL Query: “SELECT T1.name FROM employee AS T1 JOIN certificate AS T2 ON T1.eid=T2.eid JOIN aircraft AS T3 ON T2.aid=T3.aid WHERE T3.distance>5000 AND T1.salary>100000 GROUP BY T1.eid ORDER BY count (*) DESC LIMIT 1”

Each question-query pair and its corresponding database schema are populated following a NL2SQL direct generation prompt template to create one direct generation prompt example:

### Direction NL2SQL Generation Prompt Example:

Given an input Question, create a syntactically correct Oracle SQL query to run. Pay attention to using only the column names that you can see in the schema description. Be careful to not query for columns that do not exist. Also, pay attention to which column is in which table. Please double check the SQL query you generate. DO NOT use alias in the SELECT clauses. Only use the tables listed below.

```
CREATE TABLE aircraft (
  aid NUMERIC(9, 0),
  name TEXT(30),
  distance NUMERIC(6, 0),
  PRIMARY KEY (aid)
)
CREATE TABLE employee (
  eid NUMERIC(9, 0),
  name TEXT(30),
  salary NUMERIC(10, 2),
  PRIMARY KEY (eid)
)
CREATE TABLE certificate (
  eid NUMERIC(9, 0),
  aid NUMERIC(9, 0),
  PRIMARY KEY (eid, aid),
  FOREIGN KEY(aid) REFERENCES aircraft (aid),
  FOREIGN KEY(eid) REFERENCES employee (eid)
)
CREATE TABLE flight (
  flno NUMERIC(4, 0),
  origin TEXT(20),
  destination TEXT(20),
  distance NUMERIC(6, 0),
  departure_date DATE,
  arrival_date DATE,
  price NUMERIC(7, 2),
  aid NUMERIC(9, 0),
  PRIMARY KEY (flno),
  FOREIGN KEY(aid) REFERENCES aircraft (aid)
)
Question: What is the name of the employee with salary greater than 100000 and
with the most certificates to fly planes more than 5000?
SQL: “SELECT T1.name FROM employee AS T1 JOIN certificate AS T2 ON T1.eid =
T2.eid JOIN aircraft AS T3 ON T2.aid = T3.aid WHERE T3.distance > 5000 AND
T1.salary > 100000 GROUP BY T1.eid ORDER BY count(*) DESC LIMIT 1”
```

The prompt example can then be sent to the LLM model to generate the SQL query during training and testing phases. The gold (ground truth) SQL Query: “SELECT T1.name FROM employee AS T1 JOIN certificate AS T2 ON T1.eid=T2.eid JOIN aircraft AS T3 ON T2.aid=T3.aid WHERE T3.distance>5000 AND T1.salary>100000 GROUP BY T1.eid ORDER BY count (*) DESC LIMIT 1” is used to evaluate the generated SQL query using a loss function such as cross-entropy loss (e.g., using cross-entropy loss module 402) in training and a performance metric such as execution match in testing. For execution match, both gold and generated SQL queries are executed on the database using the SQL engine. The result sets of the gold and generated SQL queries are compared to check if the result sets are a match.

The training and testing flows start at either a training schemas and NL question versus (vs.) gold SQL query pairs block 424 or a testing schemas and NL question versus gold SQL query pairs block 426, respectively, where training and testing data is collected (e.g., acquired or accessed). The data collection can include exploring various data sources such as public datasets, private data collections, or real-time data streams, depending on a project's needs. In some instances, a data source is a public or online repository of information or examples pertinent to a general or target domain space. Many domains have publicly available datasets provided by governments, universities, or organizations. For example, many government and private entities offer datasets on healthcare, environmental data, and more through various portals. For proprietary needs, data might be available through partnerships or purchases from private companies that specialize in data aggregation. In other instances, a data source is a private repository of information or examples pertinent to a general or target domain space. For example, a data source can be a storage device that stores various schemas and natural language questions (including labels for corresponding gold SQL queries 403, 413).

Preprocessing may be performed on the training and testing data (from 424, 426 respectively), serving as a bridge between raw data acquisition and effective model training. The primary objective of preprocessing is to transform raw data into a format that is more suitable and efficient for analysis, ensuring that the data fed into machine learning algorithms is clean, consistent, and relevant. This step can be useful because raw data often comes with a variety of issues such as missing values, noise, irrelevant information, and inconsistencies that can significantly hinder the performance of a model. By standardizing and cleaning the data beforehand, preprocessing helps in enhancing the accuracy and efficiency of the subsequent analysis, making the data more representative of the underlying problem the model aims to solve. At block 420, the preprocessing includes populating the training and testing data (e.g., schema and NL questions 411) into the direct generation prompt template (as described above) to create direct generation prompts 413 from which the NL2SQL model 406 generates SQL queries.

Once collected, generated, preprocessed, and/or labeled, the data may then be split into the training and testing datasets. The training and testing datasets may comprise the raw data and/or preprocessed data. The training and testing datasets are typically split into at least three subsets of data: training, validation, and testing. The training set is used to fit the model, where the machine learning model learns to make inferences based on the training data. The validation set, on the other hand, is utilized to tune hyperparameters and prevent overfitting by providing a sandbox for model selection. Finally, the test set serves as a new and unseen dataset for the model, used to simulate real-world application and evaluate the final model's performance. The process of splitting ensures that the model can perform well not just on the data it was trained on, but also on new, unseen data, thereby validating and testing its ability to generalize.

Various techniques can be employed to split the data effectively, with each method aiming to maintain a good representation of the overall dataset in each subset. A simple random split (e.g., a 70/20/10%, 80/10/10%, or 60/25/15%) is the most straightforward approach, where examples from the data are randomly assigned to each of the three sets. However, more sophisticated methods may be necessary to preserve the underlying distribution of data. For instance, stratified sampling may be used to ensure that each split reflects the overall distribution of a specific variable, particularly useful in cases where certain categories or outcomes are underrepresented. Another technique, k-fold cross-validation, involves rotating the validation set across different subsets of the data, maximizing the use of available data for training while still holding out portions for validation. These methods help in achieving more robust and reliable model evaluation and are useful in the development of predictive models that perform consistently across varied datasets.

At this stage, hyperparameters may also be acquired or set for the training and testing. The hyperparameters control the overall behavior of the models. Unlike model parameters that are learned automatically during training, hyperparameters are set before training begins and have a significant impact on the performance of the model. For example, in an LLM, hyperparameters include the learning rate, batch size, number of layers, number of attention heads, hidden layer size, dropout rate, weight decay, sequence length, and embedding dimension, among others. These settings can determine how quickly a model learns, its capacity to generalize from training data to unseen data, and its overall complexity. Correctly setting hyperparameters is important because inappropriate values can lead to models that underfit or overfit the data. Underfitting occurs when a model is too simple to learn the underlying pattern of the data, and overfitting happens when a model is too complex, learning the noise in the training data as if it were signal.

At block 420, the direct generation prompts (for the training and testing data) are input into the NL2SQL model (at block 406) via a training and testing subsystem for training and/or testing. The training and testing subsystem is comprised of a combination of specialized hardware and software to efficiently handle the computational demands required for training, validating, and testing a machine learning model. On the hardware side, high-performance GPUs (Graphics Processing Units) may be used for their ability to perform parallel processing, drastically speeding up the training of complex models, especially deep learning networks. CPUs (Central Processing Units), while generally slower for this task, may also be used for less complex model training or when parallel processing is less critical. TPUs (Tensor Processing Units), designed specifically for tensor calculations, provide another level of optimization for machine learning tasks. On the software side, a variety of frameworks and libraries may be utilized, including TensorFlow, PyTorch, Keras, and scikit-learn. These tools offer comprehensive libraries and functions that facilitate the design, training, validation, and testing of a wide range of machine learning models across different computing platforms, whether local machines, cloud-based systems, or hybrid setups, enabling developers to focus more on model architecture and less on underlying computational details.

Training is the initial phase of developing machine learning models such as the NL2SQL model where the model learns to generate SQL queries (output at block 408) based on the training data (e.g., training flow 405) provided from the training datasets. During this phase, the model iteratively adjusts its internal model parameters to achieve a preset optimization condition. At blocks 402 and 404, the preset optimization condition can be achieved by minimizing the difference between the model output (e.g., generated SQL queries) and the ground truth labels (e.g., gold SQL queries) in the training data. In some instances, the preset optimization condition can be achieved when the preset fixed number of iterations or epochs (full passes through the training dataset) is reached. In some instances, the preset optimization condition is achieved when the performance on the validation dataset stops improving or starts to degrade. In some instances, the preset optimization condition is achieved when a convergence criterion is met, such as when the change in the model parameters falls below a certain threshold between iterations. This process, known as fitting, is fundamental because it directly influences the accuracy and effectiveness of the model.

In an exemplary training phase performed by the training and testing subsystem, the training subset of data is input into the machine learning algorithms to find a set of model parameters (e.g., weights, coefficients, trees, feature importance, and/or biases) that minimizes or maximizes an objective function (e.g., a loss function, a cost function, a contrastive loss function, a cross-entropy loss function, etc.). To train the machine learning algorithms to achieve accurate predictions, “errors” (e.g., a difference between a predicted label and the ground truth label) need to be minimized. In order to minimize the errors (blocks 402 and 404), the model parameters 407 can be configured to be incrementally updated by minimizing the objective function over the training phase (“optimization”). Various different techniques (e.g., stochastic gradient descent) may be used to perform the optimization. For example, to train machine learning algorithms such as an LLM, optimization can be done using back propagation. The current error is typically propagated backwards to a previous layer, where it is used to modify the weights and bias in such a way that the error is minimized. The weights are modified using the optimization function. Other techniques such as random feedback, Direct Feedback Alignment (DFA), Indirect Feedback Alignment (IFA), Hebbian learning, and the like can also be used to update the model parameters in a manner as to minimize or maximize an objective function. This cycle is repeated until a desired state (e.g., a predetermined minimum value of the objective function) is reached.

Validating is another phase of training where the model is checked for deficiencies in performance and the hyperparameters are optimized based on validation data provided from the training datasets. The validation data helps to evaluate the model's performance, such as accuracy, precision, recall, or F1-score, to gauge how well the model is likely to perform in real-world scenarios. Hyperparameter optimization, on the other hand, involves adjusting the settings that govern the model's learning process (e.g., learning rate, number of layers, size of the layers in neural networks) to find the combination that yields the best performance on the validation data. One optimization technique is grid search, where a set of predefined hyperparameter values are systematically evaluated. The model is trained with each combination of these values, and the combination that produces the best performance on the validation set is chosen. Although thorough, grid search can be computationally expensive and impractical when the hyperparameter space is large. A more efficient alternative optimization technique is random search, which samples hyperparameter combinations from a defined distribution randomly. This approach can in some instances find a good combination of hyperparameter values faster than grid search. Advanced methods like Bayesian optimization, genetic algorithms, and gradient-based optimization may also be used to find optimal hyperparameters more effectively. These techniques model the hyperparameter space and use statistical methods to intelligently explore the space, seeking hyperparameters that yield improvements in model performance.

Once a machine learning model has been trained and validated, it undergoes a final evaluation using the test data provided from the training and testing datasets, which is a separate subset of the data that has not been used during the training or validation phases. This step is important as it provides an unbiased assessment of the model's performance in simulating production operation. The test dataset serves as new, unseen data for the model, mimicking how the model would perform when deployed in actual use. During testing, the model's generated SQL queries (output at block 425) can be compared against the true values (e.g., gold SQL queries) in the test dataset using various performance metrics such as accuracy, precision, recall, and mean squared error, depending on the nature of the problem. Additionally, or alternatively, at blocks 410 and 412, the gold and generated SQL queries are executed on the corresponding database using an SQL engine (execution engine; see below in Production Flow section for detailed description) to obtain execution results. At block 416, the result sets (e.g., testing flow 415) from executing the gold and generated SQL queries are compared using an execution match evaluator to compute accuracy execution match metrics. This process helps to verify the generalizability of the model—its ability to perform well across different data samples and environments—highlighting potential issues like overfitting or underfitting and ensuring that the model is robust and reliable for practical applications. The NL2SQL model is fully validated and tested once the outputs have been reported (e.g., testing performance report) and deemed acceptable by user defined acceptance parameters (block 418). Acceptance parameters may be determined using correlation techniques such as Bland-Altman method and the Spearman's rank correlation coefficients and calculating performance metrics such as the error, accuracy, precision, recall, receiver operating characteristic curve (ROC), etc.

The production flow starts at block 422 where production schemas and natural language utterances (real-world input data) are input into the NL2SQL model via a production subsystem for inference. The production subsystem is comprised of various components for deploying machine learning models such as the NL2SQL model in a production environment. In some instances, the NL2SQL resides as a component of a larger system or service (e.g., use with an agent as described with respect to FIGS. 1-3). In some instances, the NL2SQL model and/or the inferences can be used by downstream applications to provide further information. For example, the inferences can be used to hold a conversation with a user as part of an agent or can be used to provide data analysis to a user via an analytical service such as analytics cloud-based service. Deploying the NL2SQL model includes moving the model(s) from a development environment (e.g., the training and testing subsystem, where it has been trained, validated, and tested), into a production environment where it can make inferences on real-world data (e.g., input data). This step typically starts with the model being saved after training, including its parameters and configuration such as final architecture and hyperparameters. It is then converted, if necessary, into a format that is suitable for deployment, depending on the deployment environment. For instance, a model trained in a developmental computing environment such as Python might be converted into a Java-friendly format for integration into a larger enterprise application. Deployment can be conducted on various platforms, including on-premises servers or cloud environments like OCI, AWS, Azure, Google, etc. (see below discussion of various computer and cloud architectures with respect to FIGS. 11-15).

At block 420, the input data (e.g., production schemas and natural language utterances) are populated into the direct generation prompt template (as described above) to create direct generation prompts from which the NL2SQL model generates SQL queries. At block 406, the direct generation prompt is input into the NL2SQL model via the production subsystem for inference. The NL2SQL model then translates the natural language utterance into an SQL query. This translation process includes the NL2SQL model first parsing the natural language utterance to understand the user's intent. This involves identifying the key components of the request, such as the desired action (e.g., SELECT, UPDATE), the entities involved (e.g., tables, columns), and any conditions or filters. For example, if the user says, “Show me all the customers who signed up in the last month,” the model identifies the action (retrieve data), the entities (customers), and the condition (signed up in the last month). The NL2SQL model then maps the identified entities and conditions to the corresponding elements in the schema (e.g., database schema). This step requires knowledge of the database structure, including table names, column names, and data types (which is included within the direct generation prompt template). Continuing with the example, the model needs to know that “customers” refers to a specific table, and “signed up” corresponds to a column (e.g., ‘signup_date’) in that table. Using the parsed intent and mapped schema elements, the NL2SQL model constructs a syntactically correct SQL query. This involves selecting the appropriate SQL keywords and structuring the query according to SQL syntax rules. For the example request, the LLM would generate the following SQL query:

```
  “sql
  SELECT * FROM customers WHERE signup_date >= DATE_SUB(CURDATE( ),
INTERVAL 1 MONTH);
“
```

The NL2SQL model may then validate the constructed SQL query to ensure it aligns with the user's intent and adheres to the database schema. This could involve checking for syntax errors, ensuring the correct use of SQL functions, and verifying the query against the schema. If necessary, the NL2SQL model refines the query to better match the user's request or correct any identified issues. This step might also involve asking the user for clarification if the original utterance was ambiguous. Once generated and optionally validated, the NL2SQL model outputs the SQL queries at block 425.

At blocks 410 and 412, the SQL queries are executed on the corresponding database using an SQL engine (execution engine) to obtain execution results. The execution engine executes the SQL queries on a database by following a multi-step process that involves parsing, optimizing, and executing the query. Initially, an SQL query is parsed to create an internal representation, typically an Abstract Syntax Tree (AST), which outlines the structure of the query. The engine then consults the database schema to validate the query, ensuring that all referenced tables, columns, and data types exist and are correctly used. Once validated, the query undergoes optimization, where the execution engine determines the most efficient way to access and manipulate the data, often through the use of query optimization techniques such as indexing, join algorithms, and query rewriting. This step aims to minimize resource usage and execution time. Finally, the optimized query is executed against the database. The execution engine processes the query plan, retrieves the required data from the storage engine, and applies any necessary transformations, such as filtering, sorting, or aggregating. The resulting data is then formatted and returned to the user (or user(s)) by way of production flow 417 or application that issued the query (block 414), completing the process of data retrieval.

To manage and maintain its performance, a deployed model such as the NL2SQL model may be continuously monitored to ensure it performs as expected over time. This involves tracking the model's inference accuracy, response times, and other operational metrics. Additionally, the model may require retraining or updates based on new data or changing conditions in the environment it is applied in. This can be useful because machine learning models can drift over time due to changes in the underlying data the models are making predictions on-a phenomenon known as model drift. Therefore, maintaining a machine learning model in a production environment often involves setting up mechanisms for performance monitoring, regular evaluations against new test data, and potentially periodic updates and retraining of the model to ensure it remains effective and accurate in making predictions.

### Iterative Techniques to Automate Instruction Induction for NL2SQL Prompt

As discussed above with reference to FIGS. 1-4, an NL2SQL system is powered by a deep learning model (e.g., a generative model such as an LLM) configured to convert a natural language (NL) utterance (e.g., a query posed by a user using a digital assistant or chatbot) into a structured query language (SQL) query. In most user use cases, only the database schema part is available since it can be automatically queried from the database. Conventionally to achieve higher accuracy on a specific schema, database developers who are responsible for deploying the NL2SQL model on a database can provide the schema description and, in some cases, business rule/instructions parts to attempt to arrive at the correct information. To do this, the developers can describe some tables and columns and semantics of values of these columns that could help the model to resolve ambiguity. In addition, the developers can take the time to manually add business rules and instructions to dynamically inject specific domain knowledge to generative models. However, this is a time-consuming and costly process for the developers and is prone to human error. Moreover, this approach does not provide an efficient solution where a tool can be applied to any arbitrary database to retrieve the correct information within minimal effort on the developers' part to remedy deficient baseline prompts.

To address these challenges, embodiments of the present disclosure are directed towards systems and processes for instruction induction into baseline prompts which reduces resource consumption, improves overall model accuracy, and provides a technical solution that can be applied to logical form databases across domain spaces even where the data structures may be only partially accessible or inaccessible. For the purposes of the explanation of the instruction induction into baseline prompts, the systems and processes are described hereafter as generating instructions and queries related to SQL, but as mentioned previously it should be understood that the systems and processes are not limited to SQL and the systems and processes can be configured and capable of generating instructions and queries for and in other programming languages (e.g., PRQL, GraphQL, WebAssembly, Python, R, Java, N1QL, and the like).

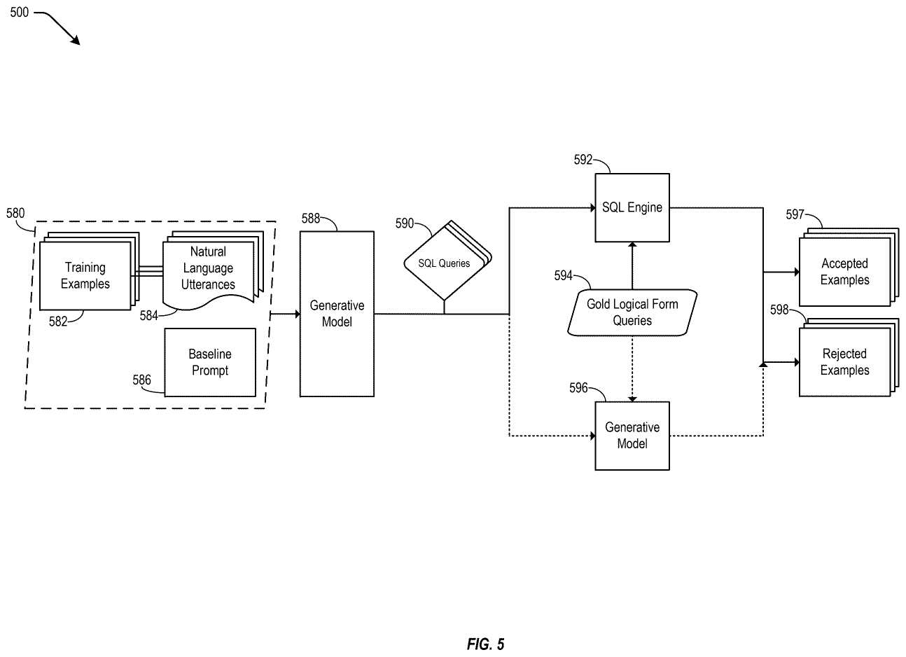

Described hereafter is a system that executes multiple workflows (see FIGS. 5-7), the system comprises several modules, each responsible for a distinct aspect of the overall process: initial prompt generation, error detection, error clustering, instruction generation, validation, and optional compression. The system may be implemented in hardware, software, firmware, or any combination thereof as a stand-alone application, a cloud service, or as part of a larger information extraction pipeline. In some embodiments, system comprises a set of software modules executing on one or more processors in a server, personal computer, or distributed computing environment. In certain embodiments, system comprises a set of software modules executing within a cloud-based infrastructure (e.g., Infrastructure as a Service (IaaS), as further described in connection with FIGS. 11-15), which leverages scalable computing and storage resources to process high volumes of data, thereby ensuring high availability and rapid response times for user interactions. System may be embodied in or accessed via various physical devices, including computers, mobile devices, appliances, networked embedded systems, or vehicles. For the purposes of the explanation of the system, the system generates instructions and queries related to SQL, but it should be understood that the techniques described herein are not limited to SQL and the system can be configured and capable of generating instructions and queries for and in other programming languages (e.g., PRQL, GraphQL, WebAssembly, Python, R, Java, N1QL, and the like).

### A. Identifying Accepted and Rejected Examples

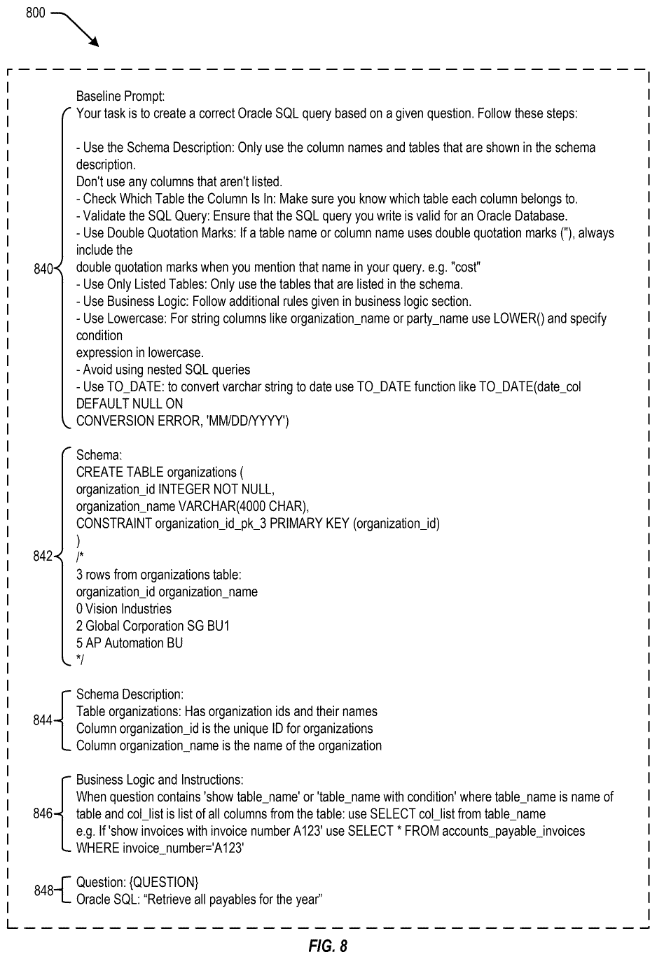

Baseline prompts without organization specific instructions (see baseline prompt in FIG. 8) are deficient and may fail to produce correct results when producing SQL queries. Baseline prompts with instruction induction may improve the efficiency of generative models, as discussed previously, by providing context and guidance on expected outputs, minimizing ambiguity, and reducing computational effort. By leveraging training examples, the training examples act as references that help the generative model better understand the task, aligning its response generation with predefined patterns or structures. By identifying which prompts are generating errors based on the training examples and augmenting the baseline prompt by dynamically injecting instructions (e.g., business logic and instructions) to remedy these errors, systems and processes as described in FIGS. 5-7 reduce the need for developers to manually create the baseline prompts. In addition, the systems and processes as described in FIGS. 5-7 reduce the need for the generative model to expend resources on correcting prompts that are not readily executable on a database, thereby optimizing processing power and memory usage.

FIG. 5 depicts a simplified example flow diagram 500 for augmenting a baseline prompt, according to various embodiments. While the diagram 500 may begin after one or more errors are returned to the NL2SQL tool from a database (e.g., NL2SQL Tool 104 described with respect to FIG. 1), it should not be considered limiting, and the flow diagram 500 may begin by input of a user, developer, and/or generative model. In some embodiments, the flow diagram 500 may include more or fewer steps than the number depicted in FIG. 5. It should be appreciated that the steps of the flow diagram 500 may be performed in any suitable order. The flow diagram 500 may be performed by some or all components of systems, devices, and/or include the processes, flows, steps, methods, or techniques as those described in relation to FIGS. 1-15.

According to some embodiments, an input 580 that includes a set of training examples 582 and a baseline prompt 586 is provided to one or more generative models 588 (also described herein as generative model, generative models, model, or models for simplicity of reference). Each example in the set of training examples 582 includes one or more natural language utterance 584 (e.g., questions from a user). The one or more generative models 588 may be various types of large language models (LLMs) with distinct capabilities, each suited to specific tasks, including interpreting natural language utterances 584 into SQL queries and executing those SQL queries when integrated with an appropriate database. In a non-limiting example, the generative model 588 may be designed to translate natural language queries into structured SQL commands; for example, a user might input, “Show me all orders from last month,” and the model generates the SQL query SELECT * FROM orders WHERE order_date>=‘2023 Sep. 1’ AND order_date<=‘2023 Sep. 30’. In addition, or alternatively, the generative model 588 may predict and complete partially written SQL queries (e.g., WHERE clauses or JOIN conditions) to streamline query creation if a natural language utterance 584 includes some or all of an attempt at a SQL query from the user. In some embodiments, the generative model 588 may be a domain-specific LLM tailored for specific industries or datasets, (e.g., healthcare or finance), and can generate specialized SQL queries, (e.g., as extracting patient data meeting specific clinical criteria or generating financial summaries).

The generative model 588 may take the input 580 and generate (or otherwise retrieve) a SQL queries 590 that corresponds to the natural language utterances 584 for each example of the set of training examples 582. For example, the following natural language utterances 584 may have been provided to the generative model 588 and SQL queries 590 may have been generated such as, but not limited to:
1. Question: “List all transactions made on Jan. 15, 2023.”
SQL Query: SELECT * FROM transactions WHERE transaction_date=‘2023 Jan. 15’
2. Question: “What are the total revenues generated last year?”
SQL Query: SELECT SUM (revenue) AS total_revenue FROM financial_records WHERE transaction_date>=‘2022 Jan. 1’ AND transaction_date<=‘2022 Dec. 31’

The SQL queries 590 are provided to one or more SQL engines 592 and/or a generative model 596 for evaluation. The dashed line indicates that the generative model 596 is optional in some embodiments. In instances where one or more SQL engines 592 are available, SQL queries 590 are evaluated to identify errors. A query is considered erroneous if it is non-executable or if its results do not match the gold SQL results. Such queries are classified as examples of errors. For instances where the one or more SQL engines 592 are not available (e.g., due to confidential restriction), a generative model 596 is prompted with the SQL queries 590 to check if the predicted SQLs are equivalent to the gold SQLs (e.g., confidential restriction). In this instance, the NL2SQL tool may prompt another generative model 596 to check if predicted SQLs are equivalent to the gold logical form SQL queries. The generative model 596 may be the same as the generative model 588 or may be different. The generative model 596, when used, may be used in an LLM-as-judge capacity. The SQL queries 590 may include both non-executable SQL queries or SQL queries where results do not match with gold SQL queries 594 as examples of errors. In some examples, a jury of generative models may be used instead of or in addition to the LLM-as-judge generative model.

Gold logical form SQL queries 594 (also known as ground truth SQL queries) are accurate and trusted SQL queries that serve as benchmarks or references for evaluating the correctness and efficiency of data retrieval, manipulation, or processing within a database. Gold logical form SQL queries 594 may be designed to represent the ideal or predicted outcome for a particular task, ensuring consistent validation of database operations, generative models, or user-generated queries. For example, a gold SQL query for calculating total sales in the last quarter could be: SELECT SUM (sales_amount) FROM transactions WHERE transaction_date BETWEEN ‘2023 Jul. 1’ AND ‘2023 Sep. 30’. Similarly, in a medical database, the gold SQL query for identifying patients diagnosed with diabetes might be: SELECT patient_id, patient_name FROM patient_records WHERE diagnosis=‘Diabetes’. In some examples, each of the training examples 582 includes an annotation or label corresponding to a gold logical form SQL query of the one or more gold logical form SQL queries 594. The generative models 588 (or other generative model) may determine an equivalence between the SQL query and the gold SQL query for each example of the set of training examples and/or the SQL query and a gold SQL query for each example of the set of training examples based on the result of executing on the SQL engine, and determine, for each training example, whether the SQL query is not executable on the database or when the SQL query is executable on the database, determining equivalence between a query result obtained via executing the SQL query and a gold query result obtained via executing the gold SQL query. For example, the system may compare each generated SQL query to the expected gold SQL, typically by executing both queries on a sample database and comparing their result sets.

As a result of the comparison of the SQL queries 590 to the gold logical form SQL queries 594, groups of accepted examples 597 (e.g., executable SQL queries or correct SQL queries) and groups of rejected examples 598 (e.g., non-executable SQL queries or incorrect SQL queries) may be identified based on one or more tests. For example, the one or more tests include determining: (i) the SQL queries are not equivalent to corresponding gold queries, (ii) the SQL queries are not able to be executed on a database, (iii) query results from executing the SQL queries on the database are not equivalent to gold query results from executing the corresponding gold queries on the database, or (iv) any combination thereof. The groups of accepted examples 597 (e.g., executable SQL queries or correct SQL queries) and groups of rejected examples 598 (e.g., non-executable SQL queries or incorrect SQL queries) may be logged or saved in a storage device for future reference. In some examples, the accepted examples 597 may not be logged for future reference since the accepted examples 597 were able to execute properly and were determined to be correct.

### B. Clustering Rejected Examples

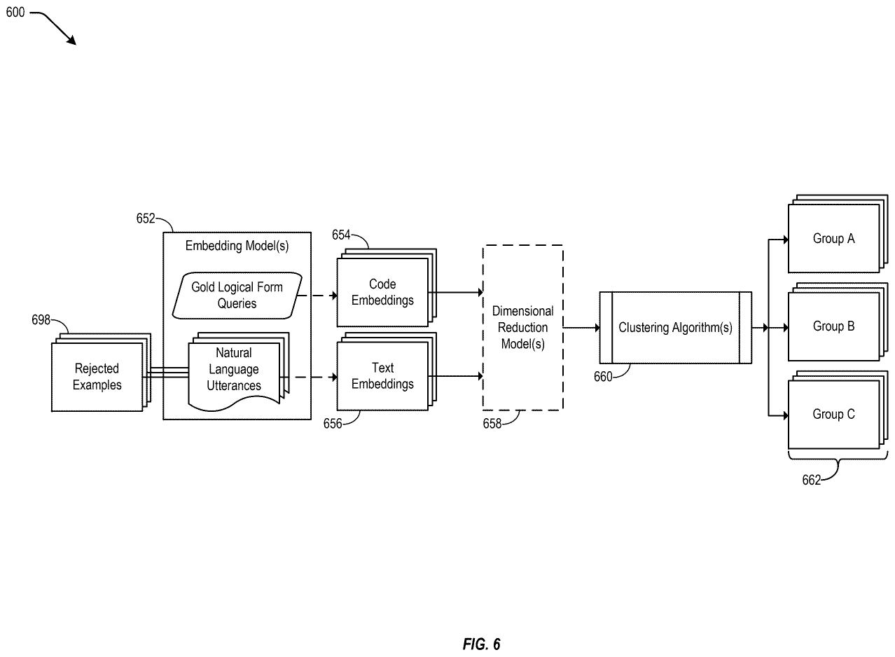

FIG. 6 depicts a simplified example flow diagram 600 for augmenting a baseline prompt, according to various embodiments. While the diagram 600 may begin at receiving rejected examples 698 (examples of rejected examples 598 as described with respect to FIG. 5), it should not be considered limiting, and the flow diagram 600 may begin by input of a user, developer, and/or generative model. In some embodiments, the flow diagram 600 may include more or fewer steps than the number depicted in FIG. 6. It should be appreciated that the steps of the flow diagram 600 may be performed in any suitable order. The flow diagram 600 may be performed by some or all components of systems, devices, and/or include the processes, flows, steps, methods, or techniques as those described in relation to FIGS. 1-15.

The rejected examples 698, and associated natural language utterances, may be used to generate embeddings for analysis. For example, one or more embedding model(s) 652 may generate code embeddings 654 from gold logical form SQL queries (e.g., gold logical form SQL queries 694) and text embeddings 656 from natural language utterances from the rejected examples 698. For example, a text embedding may be an embedding of a question in the natural language utterance. In some examples, an embedding vector may be formed by concatenating the text embeddings 656 and the code embeddings 654 by merging two distinct vector representations, respectively for sets of queries. In some examples, forming the embedding vector may include aligning the dimensions of both text and code embeddings, by applying padding, truncation, or/and dimensionality reduction (e.g., dimensional reduction model(s) 658). According to some embodiments, the vectors may be appended sequentially to create a continuous extended representation. For instance, a text embedding [0.25, 0.48, 0.72] derived from the phrase “calculate revenue” can be concatenated with a code embedding [0.14, 0.67, 0.89, 0.20] generated from the SQL query SELECT SUM (revenue) FROM transactions; resulting in a combined vector [0.25, 0.48, 0.72, 0.14, 0.67, 0.89, 0.20]. This embedding vector preserves both the semantic meaning of the text and the functional properties of the code. In some examples, the dimensional reduction model(s) 658 may be applied on the embedding vectors to project the embedding vectors into a lower dimension for better clustering quality.

According to some embodiments, the clustering algorithm(s) 660 take embedding vector inputs and group similar data points (represented as multidimensional vectors) into clusters based on their proximity or similarity in embedding space. The clustering algorithm(s) 660 analyze patterns among the embedding vectors to identify inherent patterns or structures within the data. The clustering algorithm(s) 660 can include, without limitation, agglomerative clustering, k-means clustering, density-based clustering algorithms (e.g., DBSCAN (Density-Based Spatial Clustering of Applications with Noise)), and suitable equivalents. The clustering algorithm(s) 660 can group vectors based on areas of high density for identifying clusters of arbitrary shapes and separating outliers. The clustering algorithm(s) 660 can group subsets of similar rejected examples into one or more groups 662 based on an identified pattern of error for further processing. Suppose several errors involve the model failing to apply LOWER( ) to string comparisons (e.g., party_name, organization_name, approval_status). These would be clustered together, as they reflect a common pattern of error. Grouping similar rejected examples in the same group for generation helps to identify patterns of error, avoid generating similar instructions (if done one by one), and make the generative model focus on generating instructions for some specific queries (or example areas). Generating instructions for each group in the groups 662 may also help to reduce lengths of the instruction generation prompts. Generating groups 662 may also improve the quality of instruction generation and reduce processing power demands on the generative model since the rejected examples are not run one by one, but instead of grouped by similarity.

Patterns of error in text and code embeddings of SQL queries can arise from various factors, including misalignment between semantic meaning and syntactic structure, incomplete contextual representation, or inconsistencies in training data. For instance, text embeddings derived from natural language descriptions of SQL queries may fail to capture critical structural elements, such as specific keywords, operators, or table relationships, leading to inaccurate or incomplete queries. Similarly, code embeddings may exhibit errors in capturing the logical flow or dependencies within a query, such as incorrectly representing JOIN conditions or omitting constraints like WHERE clauses. These errors can manifest as mismatched embeddings that fail to align the intended task with the generated query, leading to poor performance in tasks like query generation or database interaction. In addition, patterns of error may include overfitting or bias in the text and/or code embeddings, where specific SQL constructs are disproportionately emphasized due to imbalanced training data, resulting in suboptimal performance on unseen queries. Text and/or code embeddings may also inaccurately represent numerical or date values, causing errors in filtering or aggregation tasks. For example, a text and/or code embedding may misrepresent fiscal year date ranges when translating natural language queries, leading to incorrect results.

### C. Augmenting the Baseline Prompt

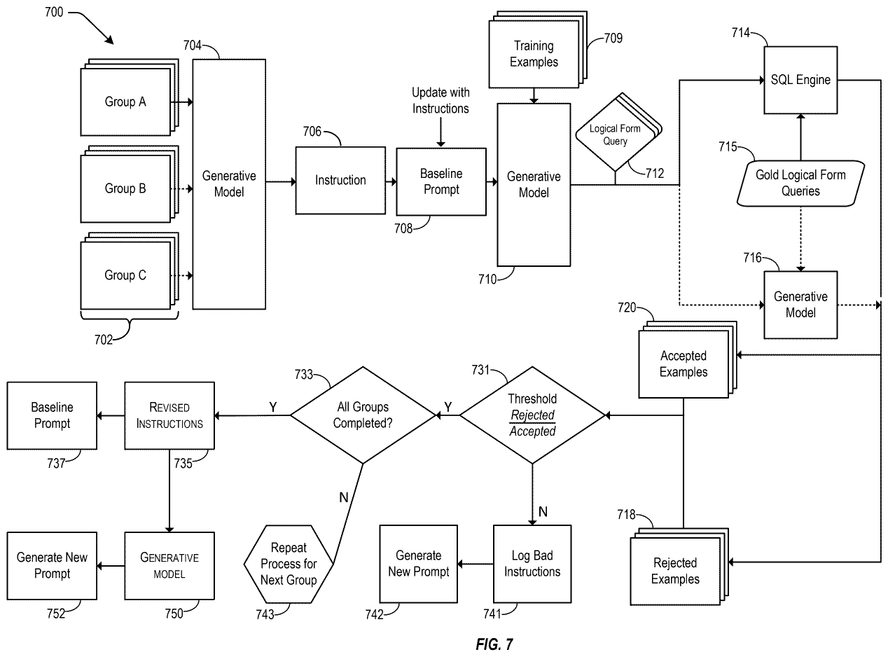

FIG. 7 depicts a simplified example flow diagram 700 for augmenting a baseline prompt, according to various embodiments. While the flow diagram 700 may begin at receiving groups 702 (examples of groups 662 as described with reference to FIG. 6), it should not be considered limiting, and the flow diagram 700 may begin by input of a user, developer, and/or generative model. In some embodiments, the flow diagram 700 may include more or fewer steps than the number depicted in FIG. 7. It should be appreciated that the steps of the flow diagram 700 may be performed in any suitable order. The flow diagram 700 may be performed by some or all components of systems, devices, and/or include the processes, flows, steps, methods, or techniques as those described in relation to FIGS. 1-15.

As shown in FIG. 7, the system identifies the largest error group and generates candidate instructions aimed at addressing the underlying pattern of error. The largest error group being the group with the largest number of data points or rejected examples. To do this, the system uses a specially crafted prompt, providing the schema, schema description, and a list of errors (e.g., questions, gold SQL, and incorrect SQL). The model is instructed to propose generic, reusable instructions (not specific to the examples). For example, Group A may be identified as comprising the largest number of data points or examples with errors in the groups 702 of rejected examples and may be assessed first by the generative model 704 to generate instruction 706.

In a non-limiting example, the generative model 704 may be prompted to generate instruction 706 with the following prompt:

“Your task is to create a list of instructions to reduce generation errors of a text-to-SQL model by augmenting the model's prompt with these additional instructions. Given a database schema, a list of natural language questions, the corresponding correct and wrong SQLs generated by a text-to-SQL model, please give some instructions to help avoid these mistakes following below guidelines:
1. The generated instructions should be generic, rather than specific to a particular example.
2. The generated instructions should be in the “bullet-point” format, with no more than 50 words per bullet-point.
3. The generated instructions must be generic, and they should NEVER refer to any Error Case example.
4. Keep the number of generated instructions as small as possible.

Schema:{SCHEMA}
Schema Descriptions: {SCHEMA_DESCRIPTIONS}
Text-to-SQL Generation Errors: {ERRORS}
Now generate the instructions.”

For example, the system provides the model with four error cases, all involving string matching without LOWER( ) The model (provided the prompt above as input) generates an instruction: For string columns such as organization_name, party_name, party_site_name, approval_status, or workflow_approval_status, always use the LOWER( ) function and write the condition in lowercase.

The instruction 706 is then added to the instruction section of the baseline prompt 708 and provided to a generative model 710 to evaluate the performance of the generative model 710 on the training examples 709 or a subset thereof (e.g., the set of training examples 582, the subset of rejected examples 598, 698, 718, or a group of rejected examples (the largest group being evaluated)). To evaluate the new instruction (e.g., instruction added to the baseline prompt 708), the training examples 709 may be provided to the generative model 710 along with the baseline prompt 708 to cause the generative model 710 to generate a set of SQL queries 712 (similar to FIG. 6). The SQL queries 712 may be provided to the SQL engine 714 to identify if the SQL queries 712 are executable and/or provide the correct results. Similar to FIG. 6, gold SQL queries 715 may be provided for comparison in order to determine a new subset of rejected examples 718 and a new subset of accepted examples 720.

To account for randomness, the system may perform bootstrapped sampling, running this evaluation process multiple times with different random seeds from the training examples 709 and averaging the results. Bootstrapped sampling is a statistical technique used to estimate the reliability and stability of a model's performance by repeatedly evaluating it on different randomly-sampled subsets of data or under varying initialization conditions. In the current context, bootstrapped sampling is used to assess whether newly generated instruction 706 genuinely improve the accuracy of the generative model 710 to generate a set of SQL queries 712 for a target error group and/or for the overall training set (the training examples 709). For example, for each test: the generative model 710 is initialized or prompted with a particular random seed, which influences the training examples randomly sampled and how the generative model 710 generates SQL queries for the provided natural language questions. The “seed” is a numeric value used to initialize the random number generator in the generative model's sampling mechanism. Each seed produces a slightly different sequence of random numbers, which in turn affects how the generative model 710 generates text (such as SQL queries). Seeds can be generated programmatically, often using system time, counters, or a dedicated random number generator. The system then runs the generative model 710 across the training examples 709 or a subset thereof, collects the generated SQL queries, and compares them to the gold SQL queries 715 using one or more evaluation techniques described herein such as execution match or result set comparison. As discussed in more detail in FIG. 6, the generative model 716 may be a “LLM-as-judge” generative model which may work in addition to, or alternatively from, the SQL engine 714 if the SQL engine 714 is unavailable or if supplemental information is desired such as evaluation of the generated SQL queries. The accuracy for each run is recorded. This approach can be important for generative models, which can exhibit variability in their outputs depending on random initialization parameters (often referred to as “random seeds”) or stochastic elements within the prompt generation process. By performing multiple evaluations with different random seeds, the system can ensure that observed improvements are not due to chance and are robust across a range of conditions.

After completing all runs (with, for example, 10, 20, or more different seeds), the system aggregates the results (e.g., by calculating the average accuracy across all runs). The system records the accuracy for the entire training set of rejected examples (or just the error group such as Group A). If this aggregate such as average is an improvement over the prior prompt and meets or exceeds the threshold for acceptance, the instruction 706 is kept within the baseline prompt 708. More specifically, the rejected examples 718 and/or the accepted examples 720 may undergo one or more comparisons 731 to a performance threshold, also referred to herein as “the threshold”, (e.g., rejected examples/accepted examples is greater than or equal to 0.75). In some examples, the threshold may be determined dynamically by the generative model or may be pre-determined. In addition, or alternatively, the threshold may be represented as a percentage of rejected examples to accepted examples or conversely, accepted examples to rejected examples (e.g., 5%, 10%, 15%, 20%, 25%, 30%, 35%, 40%, 45%, 50%, 55%, 60%, 65%, 70%, 75%, 80%, 85%, 90%, 95%, and 100%). In an example, if the threshold is met or exceeded, then the process may log the instructions which correctly produced SQL results and append them to the baseline prompt 737 by way of block 735. By way of a non-limiting example, the NL2SQL tool may identify how many new rejected examples 718 have occurred versus how many new accepted examples 720 have occurred. For example, if there were four total examples, and on average only one was rejected, which meets or exceeds the threshold, then the new baseline prompt 708 may be considered successful.

If the new instructions improve accuracy for the training examples 709 or a subset thereof and do not cause regression (e.g., measured against prior accuracy record(s)), they are accepted and added to the baseline prompt 737. If not, the system may ask the generative model 704 to revise the instructions, using a revision prompt that includes the prior rejected instructions. According to certain embodiments, if the threshold is not met, the instructions for the current group (e.g., Instruction A) will be logged at block 741 and included in generation of a new prompt at block 742. The new prompt may include the updated (e.g., revised, appended, etc.) instructions and optionally the bad instruction.

In a non-limiting example, the generative model 704 may be prompted to generate revised instructions with the following prompt:

“Your task is to revise a list of instructions to reduce generation errors of a text-to-SQL model by augmenting the model's prompt with these additional instructions. Given a database schema, a list of natural language questions, the corresponding correct and wrong SQLs generated by a text-to-SQL models, a list of previously generated instructions that have not worked properly yet, please give some instructions to help avoid these mistakes following below guidelines:
1. The generated instructions should be generic, rather than specific to a particular example.
2. The generated instructions should be in the “bullet-point” format, with no more than 50 words per bullet-point.
3. The generated instructions must be generic, and they should NEVER refer to any Error Case example.
4. Keep the number of generated instructions as small as possible.

Schema:{SCHEMA}
Schema Descriptions: {SCHEMA_DESCRIPTIONS}
Text-to-SQL Generation Errors: {ERRORS}
Previously Generated Instructions: {PREVIOUSLY_REJECTED_INSTRUCTIONS}
Now revise the instructions.”

Once the revised instructions for a group have been identified, the revised instructions may be added the baseline prompt at block 742 and re-evaluated as described above.

Once a new or revised instruction set is accepted (e.g., met or exceeded the threshold), the system uses the updated prompt to re-run the training examples 709 or a subset thereof (e.g., the set of training examples 582 or the subset of rejected examples 598, 698, 718) and collect a new set of errors and associated examples. The process of clustering, instruction generation, and validation/evaluation is repeated for each new set of errors and associated examples. The system iteratively continues this loop addressing the next largest error group in each cycle until no further improvements can be made or a predefined maximum number of iterations is reached. An iterative process is a systematic approach in which a sequence of actions or steps is repeated multiple times, each cycle building on the results of the previous one to progressively refine or improve a solution, e.g., the instructions to be included in the baseline prompt. In each iteration, feedback or outcomes from earlier steps are analyzed and used to guide adjustments or enhancements in subsequent cycles, continuing until a desired level of performance or a stopping condition is reached. For example, after addressing all string-casing errors, the next largest group may involve incorrect handling of date comparisons. The system provides relevant errors to the generative model 704 and receives an instruction such as: When a question has a condition on a date, convert the value to ‘MM/DD/YYYY’ format and use the TO_DATE function with ‘DEFAULT NULL ON CONVERSION ERROR’. This is validated, and, if effective, added to the instructions in the baseline prompt. Each iteration progressively reduces the number of errors, generates additional instructions, and optimizes or augments the baseline prompt.

After several instruction induction rounds, the prompt may become quite extensive (e.g., length as measured in number of tokens) and verbose. While this comprehensive set is highly effective for accuracy, it increases the length of the prompt, which can directly impact inference latency and computational cost for the model. To improve efficiency, the system can initiate an optional compression step using generative model 750 to systematically shorten, consolidate, or simplify the instructions without sacrificing the achieved accuracy. Compression may be applied after one or more rounds of instruction induction or after all rounds of instruction induction (no further improvements can be made or a predefined maximum number of iterations is reached), once the system has accepted new instructions and augmented the baseline prompt. Here, the system groups similar instructions and uses a prompt to shorten or consolidate them, aiming to preserve meaning while reducing token count. More specifically, the compression step is a controlled loop that leverages the generative model's ability to rewrite and simplify text. The workflow proceeds as follows:

### 1. Grouping Instructions for Compression

The system clusters the instruction set into groups of similar or related instructions. This grouping may use semantic embeddings or simple keyword matching.
Larger groups may be prioritized for compression since they offer more opportunity for consolidation.

### 2. Sampling an Instruction Group

The system selects an instruction group for compression, often with higher probability for larger groups.
For example, if there are several instructions about string column handling, these are grouped together.

### 3. Compression Prompt to Generative Model

The selected group of instructions is provided to the generative model 750 with a specialized prompt designed to produce shortened, non-redundant versions.
The compression prompt from the document can be:

### Instructions_Reduction_Prompt:

“Your task is to shorten a list of text-to-SQL generation instructions. Please follow the below guidelines:
Keep the original instructions as much as possible and only simplify them if they are too long or contain repeated information,
Return only the list of shortened instructions and nothing else, Put each shortened instruction on a separate line.Current list of instructions: {INSTRUCTIONS} Simplified list of instructions:”

### 4. Generative Model Compression Execution

The generative model 750, potentially initialized with a random seed for diversity, rewrites the instruction group, removing redundancy, merging similar points, and condensing language while preserving content.

### 5. Formation of the Shortened Prompt

The system replaces the original instruction group in the prompt with the newly compressed set to generate new baseline prompt 752.
The complete new baseline prompt 752 is reconstructed with the compressed instructions.

### 6. Validation of the Shortened Prompt

The system re-runs the evaluation against the full training set or a subset thereof using the compressed prompt.
This may involve multiple runs with different random seeds to ensure that accuracy is maintained.

### 7. Acceptance Criteria

The compressed instructions are only adopted if the prompt's accuracy with the compressed instructions meets or exceeds the accuracy obtained with the uncompressed instructions.
If accuracy drops, the system may retry compression with another group or another seed, up to a maximum number of trials.

### 8. Iteration and Stopping Condition

The compression loop continues, compressing further instruction groups, until either no further reductions are possible without loss of accuracy or the maximum number of compression trials has been reached.

Suppose instructions for string matching and for table/column selection are somewhat redundant. The generative model 750 merges and simplifies these, reducing overall length. The system then validates the compressed instructions as before, ensuring accuracy is not compromised. Only if accuracy is maintained or improved are the compressed instructions adopted and used to generate a new baseline prompt 752 (e.g., incorporated into the instruction section of the baseline prompt).

As should be understood, the generative models (e.g., 704, 710, 716, 750, etc.) described with respect to FIG. 5-7 can all be the same model with multiple calls being made to the same model (effectively asking the same model to take on different roles such as instruction generation, NL2SQL, validation/evaluation, compression, etc. or some models be the same generative model and others different generative models, or all of the models may be implemented using different generative models without departing from the spirit and scope of the present disclosure.

FIG. 8 depicts a simplified diagram for an example baseline prompt 800, according to various embodiments. The baseline prompt 800 may include, without limitation, several sections that provide descriptive information to a generative model to arrive at a result. In this non-limiting example, this baseline prompt 800 may be an example of baseline prompt 586 with respect to FIG. 5 with additional instructions (e.g., business logical and instructions 846). The baseline prompt 800 includes one or more description(s) 840. The description(s) 840 provides instructions to the generative model for interpreting the sections of the baseline prompt 800 as well as contexts of natural language utterances in the form of one or more question(s) 848 (e.g., NL utterance). In this example, the sections can include one or more schema(s) 842, schema description(s) 844, and business logic and instruction(s) 846. One or more of the sections within the baseline prompt 800 may be adjusted with the inducted instructions.

The schema(s) 842 are structured frameworks or blueprints that define the organization, relationships, and format of data within the database. The schema(s) 842 may specify parameters such as field names, data types, constraints, and/or relationships between elements. The schema(s) 842 outlines the tables, columns, and relationships that are important to manage information stored for later retrieval. The schema description(s) 844 may include organization and/or database specific information.

The business logical and instruction(s) 846 may include sets of rules, processes, and/or decision-making frameworks that dictate how data and operations are structured and executed to meet organization database formats. For example, the business logic and instruction(s) 846 may include constraints and/or organizational rules for data management. Generative models may use business logical and instruction(s) 846 to structure inputs, outputs, and constraints to ensure the model performs tasks aligned with operational needs, such as formatting certain types of SQL queries (stemming from natural language utterances) or adhering to organizational formatting standards.

### D. Production Baseline Prompt

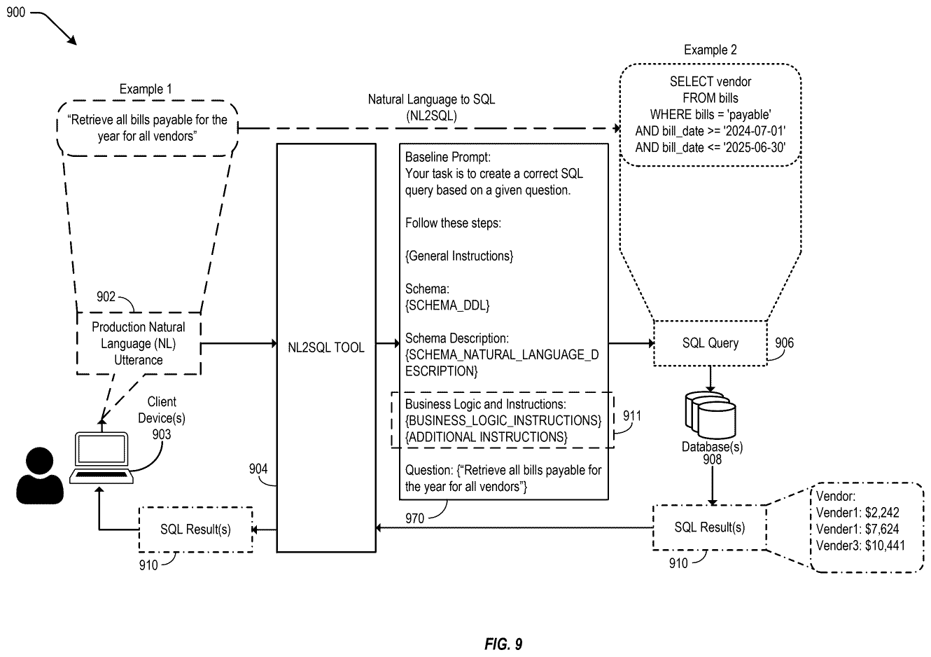

As a result of methods, steps, and/or processes with respect to FIGS. 5-8, an augmented baseline prompt with inducted instructions can be generated with improved instructions to account for errors in a generated SQL query. FIG. 9 depicts a simplified diagram 900 for an example NL2SQL prompt generation with an augmented baseline prompt, according to various embodiments. As discussed above and similar to FIG. 1, one or more client device(s) 903 submits a production natural language (NL) utterance 902 to a NL2SQL tool 904 (e.g., a chatbot) which may include a production generative model. “Production” may refer to an aspect of a deployed NL2SQL tool 904 which is used by one or more organizations to interact with one or more client device(s) 903. These interactions happen when a user is accessing a specific website or server requesting information. For example, a user can attempt to pull payable records from an accounting database by chatting (e.g., chat 206) with a chatbot (e.g., SQL agent 202) hosted (or linked) to the website and provide the utterance, “Retrieve all bills payable for the year for all vendors”.

The NL utterance 902 is received by one or more NL2SQL tools 904. To process the question, the NL2SQL tool 904 appends (or otherwise adds) the NL utterance 902 to a baseline prompt 970 along with one or more instructions (discussed in more detail with respect to FIG. 8), in addition to inducted instructions 911 determined and added with respect to FIGS. 5-8, so that a generative model (e.g., SQL large language model 375) may translate (or otherwise transform) the NL utterance 902 to a logical form such as SQL query 906. The baseline prompt 970 may include an instruction that sets a framework for evaluating or guiding the behavior of the generative model.

The NL2SQL tool 904 provides the baseline prompt 970, which includes the NL utterance 902, to a generative model. The SQL query 906 may be applied by the generative model (or by the NL2SQL tool 904) to one or more database(s) 908 (e.g., SQL database(s) 377) and the database(s) 908 provide one or more SQL result(s) 910. In this non-limiting example, the NL2SQL tool 904 may receive the SQL results 910 (as discussed in FIG. 1) and provide the SQL results 910 (e.g., production query results) to the one or more client device(s) 903. While the inducted instructions 911 are added to the business logic and instructions section, it should not be considered limiting, and it is anticipated within the scope of this disclosure that any suitable section in the baseline prompt can be augmented (e.g., 840, 842, 844, 846, 848 with respect to FIG. 8).

Non-limiting examples of inducted instructions 911 for the baseline prompt 970 include:
1. When question contains ‘show table_name’ or ‘table_name with condition’ where table_name is name of table and col_list is list of all columns from the table:

use SELECT col_list from table_name
e.g. If ‘show invoices with invoice number A123’ use SELECT * FROM
accounts_payable_invoices WHERE invoice_number=‘A123’

2. When question contains ‘show col_name’ or ‘col_name with condition’ where col_name is name of the column in table_name:

use SELECT col_name from table_name
e.g. If ‘show invoice amount with invoice number A123’ use SELECT invoice_amount
FROM accounts_payable_invoices WHERE invoice_number=‘A123’

3. When question contains columns organization_name/party_name/party_site_name/approval_status/workflow_approval_status name as ‘Name’:

use LOWER( ) keyword e.g. WHERE LOWER(organization_name)=‘name’/ WHERE
LOWER(party_name)=‘name’/ WHERE LOWER(party_site_name)=‘name’/ WHERE
LOWER(approval_status)=‘name’/ WHERE LOWER(workflow_approval_status)
=‘name’ where ‘name’ is in lowercase

4. When question contains payment status:

use accounts_payable_invoices.payment_status_flag
If payment is not paid: use WHERE
accounts_payable_invoices.payment_status_flag = ‘N’
If payment is partially paid: use WHERE
accounts_payable_invoices.payment_status_flag = ‘P’
If payment is fully paid: use WHERE
accounts_payable_invoices.payment_status_flag = ‘Y’
If payment is unpaid: use WHERE accounts_payable_invoices.payment_status_flag
IN (‘N’, ‘P’) which means they are either not paid or partially paid

5. When question contains payment status or approval status or workflow status:

use only column values listed in schema description
When question contains ‘for party var’ or ‘for var’ or ‘for supplier var’ where ‘var’ is
full name of
party: use WHERE parties.party_name = var

6. When question contains ‘for party site var’ or ‘for var’ where ‘var’ is alphanumeric name of party site in uppercase:
   use WHERE party_sites.party_site_name=var
7. When question contains ‘owned by var’ or ‘by organization var’ where ‘var’ is name of an organization:
   use JOIN on organization_id and use WHERE organization.organization_name=var
8. When question contains ‘due in n weeks’ where ‘n’ is number of weeks:
   use WHERE num_weeks_before_due_date<=n
9. When question contains ‘overdue by n weeks’ where ‘n’ is number of weeks:
   use WHERE num_weeks_before_due_date>=n
10. When question ‘amount paid’ or ‘settled amount’
   use amount_paid column
11. When question ‘invoice amount’ or ‘billed amount’
   use invoice_amount column
12. When question has condition date var_dt, convert to ‘MM/DD/YYYY’ format as var_formatted_dt

use WHERE TO_DATE(date_col DEFAULT NULL ON CONVERSION ERROR,
‘MM/DD/YYYY’) = TO_DATE (var_formatted_dt,‘MM/DD/YYYY’) where date_col is
‘due_date’ or ‘discount_date’
use of ‘DEFAULT NULL ON CONVERSION ERROR’ avoids errors arising from existing
data

13. When question has condition on var_dt

use WHERE TO_DATE(date_col DEFAULT NULL ON CONVERSION ERROR,
‘MM/DD/YYYY’) = TO_DATE (var_formatted_dt,‘MM/DD/YYYY’)

14. When question has condition after var_dt

use WHERE TO_DATE(date_col DEFAULT NULL ON CONVERSION ERROR,
‘MM/DD/YYYY’) > TO_DATE (var_formatted_dt,‘MM/DD/YYYY’)

15. When question has condition before var_dt

use WHERE TO_DATE(date_col DEFAULT NULL ON CONVERSION ERROR,
‘MM/DD/YYYY’) < TO_DATE
(var_formatted_dt,‘MM/DD/YYYY’)

### E. Illustrative Method

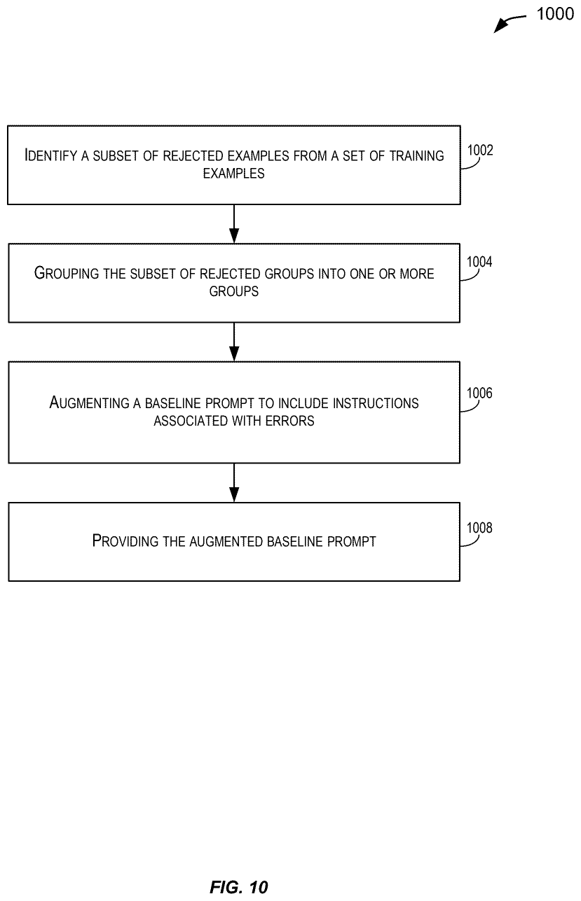

FIG. 10 is a flowchart illustrating a process 1000 for augmenting a baseline prompt, according to various embodiments. The processing depicted in FIG. 10 may be implemented in software (e.g., code, instructions, a program) executed by one or more processing units (e.g., one or more processors, cores) of the respective systems, hardware, or combinations thereof described throughout. The software may be stored on a non-transitory storage medium (e.g., on a memory device). Although the methods presented in FIG. 10 depict the various processing steps occurring in a particular sequence or order, this is not intended to be limiting. In certain alternative embodiments, the steps may be performed in parallel and/or in a different order. In certain embodiments, such as in the embodiments depicted in FIGS. 1-9, the processing depicted in FIG. 10 may be performed by a NL2SQL tool, as described with respect to FIGS. 1-9, a system, as described with respect to FIGS. 5-9 and/or a training, testing, and deployment or production system or subsystem, as described with respect to FIG. 4.

At step 1002, a subset of rejected examples is identified from a set of training examples. The subset of rejected examples include logical form queries that fail one or more tests. In some instances, the set of training examples is accessed, where each example of the set of training examples includes a natural language utterance. A logical form query that corresponds to the natural language utterance is generated by a generative model for each example of the set of training examples, and performance of the generative model is evaluated using the logical form query generated for each example of the set of training examples. The identifying of the subset of rejected examples may be performed based on the evaluating, and the one or more tests include determining: (i) the logical form queries are not equivalent to corresponding gold queries, (ii) the logical form queries are not able to be executed on a database, (iii) query results from executing the logical form queries on the database are not equivalent to gold query results from executing the corresponding gold queries on the database, or (iv) any combination thereof.

At step 1004, the subset of rejected examples is grouped into one or more groups of rejected examples based on similarity between the subset of rejected examples. In some instances, grouping the subset of rejected examples comprises grouping based on a similarity between embedding vectors for each example of the subset of rejected examples. In some instances, the embedding vectors are generated, where the generating the embedding vectors comprises: generating a text embedding for the natural language utterance of each rejected example of the subset of rejected examples; generating a code embedding for a gold query of each rejected example of the subset of rejected examples; and concatenating the text embedding and the code embedding for each rejected example to generate the embedding vectors for the subset of rejected examples, and wherein the similarity between the subset of rejected examples is based on the embedding vectors.

At step 1006, a baseline prompt is augmented to include instructions associated with errors in at least some rejected examples in the subset of rejected examples. The augmenting is an iterative process comprising: (a) generating, by a generative model, instructions for a group of the one or more groups of rejected examples based on a pattern of error identified for the group of rejected examples, (b) updating the baseline prompt to include the instructions for the group of rejected examples, (c) generating, by a generative model based on the updated baseline prompt, a logical form query that corresponds to the natural language utterance for each example of: the set of training examples, the subset of rejected examples, or the group of rejected examples, (d) evaluating performance of the second generative model using the logical form query generated for each example, and (e) in response to the performance meeting or exceeding a threshold, updating the baseline prompt to include the instructions for the group of rejected examples, identifying another subset of rejected examples from the set of training examples or the subset of rejected examples, grouping the another subset of rejected examples into another one or more groups of rejected examples, and repeating the iterative process (a)-(e) using the baseline prompt augmented with the instructions from one or more prior cycles of the iterative process and the another one or more groups of rejected examples.

In some instances, the group is a group comprising the largest number of data points or examples with errors from the one or more groups of rejected examples.

In some instances, the iterative process further comprises in response to the performance not meeting or exceeding a threshold, revising the instructions for the group of rejected examples or the another group of rejected examples until the performance meets or exceeds the threshold using the revised instructions or a predetermined number of iterations is met.

In some instances, a prompt is generated comprising the instructions after the iterative process has completed or after one or more cycles of the iterative process has completed, compressed instructions are generated by a generative model based on the instruction, and the baseline prompt is updated to include the compressed instructions.

In some instances, the evaluating comprises: determining, by one or more generative models, equivalence between the logical form query and a gold logical form query for each example of: the set of training examples, the subset of rejected examples, or the group of rejected examples; or executing the logical form query and a gold logical form query for each example of: the set of training examples, the subset of rejected examples, or the group of rejected examples on a database, and determining, for each example, whether the logical form query is not executable on the database or when the logical form query is executable on the database, equivalence between a query result obtained via executing the logical form query and a gold query result obtained via executing the gold logical form query. The evaluating may be performed using bootstrap sampling such that the logical form query is randomly selected from the examples for the evaluating.

At step 1008, the augmented baseline prompt is provided. For example, the augmented baseline prompt may be stored in one or more data storage devices for use in deployment of a NL2SQL tool or agent as described with respect to FIGS. 1-3. In some instances, once deployed, a production natural language utterance may be received from a client device, where the production natural language utterance includes a data request associated with a production database. A prompt may be generated based on the production natural language utterance and the updated baseline prompt which includes the instructions, a logical form query associated with the production natural language utterance may be generated by a production generative model (e.g., the generative model evaluated in the iterative process), the logical form query associated with the production natural language utterance may be executed on the production database to obtain a production query result, and the production query result may be provided to the client device.

As used herein, the terms “about,” “similarly,” “substantially,” and “approximately” are defined as being largely but not necessarily wholly what is specified (and include wholly what is specified) as understood by one of ordinary skill in the art. In any disclosed embodiment, the term “about,” “similarly,” “substantially,” or “approximately” may be substituted with “within [a percentage] of” what is specified, where the percentage includes 0.1 percent, 1 percent, 5 percent, and 10 percent, etc.

As used herein, when an action is “based on” something, this means the action is based at least in part on at least a part of the something.

### Illustrative Systems

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 11 is a block diagram 1100 illustrating an example pattern of an Iaas architecture, according to at least one embodiment. Service operators 1102 can be communicatively coupled to a secure host tenancy 1104 that can include a virtual cloud network (VCN) 1106 and a secure host subnet 1108. In some examples, the service operators 1102 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 1106 and/or the Internet.

The VCN 1106 can include a local peering gateway (LPG) 1110 that can be communicatively coupled to a secure shell (SSH) VCN 1112 via an LPG 1110 contained in the SSH VCN 1112. The SSH VCN 1112 can include an SSH subnet 1114, and the SSH VCN 1112 can be communicatively coupled to a control plane VCN 1116 via the LPG 1110 contained in the control plane VCN 1116. Also, the SSH VCN 1112 can be communicatively coupled to a data plane VCN 1118 via an LPG 1110. The control plane VCN 1116 and the data plane VCN 1118 can be contained in a service tenancy 1119 that can be owned and/or operated by the IaaS provider.

The control plane VCN 1116 can include a control plane demilitarized zone (DMZ) tier 1120 that acts as a perimeter network (e.g., portions of a corporate network between the corporate intranet and external networks). The DMZ-based servers may have restricted responsibilities and help keep breaches contained. Additionally, the DMZ tier 1120 can include one or more load balancer (LB) subnet(s) 1122, a control plane app tier 1124 that can include app subnet(s) 1126, a control plane data tier 1128 that can include database (DB) subnet(s) 1130 (e.g., frontend DB subnet(s) and/or backend DB subnet(s)). The LB subnet(s) 1122 contained in the control plane DMZ tier 1120 can be communicatively coupled to the app subnet(s) 1126 contained in the control plane app tier 1124 and an Internet gateway 1134 that can be contained in the control plane VCN 1116, and the app subnet(s) 1126 can be communicatively coupled to the DB subnet(s) 1130 contained in the control plane data tier 1128 and a service gateway 1136 and a network address translation (NAT) gateway 1138. The control plane VCN 1116 can include the service gateway 1136 and the NAT gateway 1138.

The control plane VCN 1116 can include a data plane mirror app tier 1140 that can include app subnet(s) 1126. The app subnet(s) 1126 contained in the data plane mirror app tier 1140 can include a virtual network interface controller (VNIC) 1142 that can execute a compute instance 1144. The compute instance 1144 can communicatively couple the app subnet(s) 1126 of the data plane mirror app tier 1140 to app subnet(s) 1126 that can be contained in a data plane app tier 1146.

The data plane VCN 1118 can include the data plane app tier 1146, a data plane DMZ tier 1148, and a data plane data tier 1150. The data plane DMZ tier 1148 can include LB subnet(s) 1122 that can be communicatively coupled to the app subnet(s) 1126 of the data plane app tier 1146 and the Internet gateway 1134 of the data plane VCN 1118. The app subnet(s) 1126 can be communicatively coupled to the service gateway 1136 of the data plane VCN 1118 and the NAT gateway 1138 of the data plane VCN 1118. The data plane data tier 1150 can also include the DB subnet(s) 1130 that can be communicatively coupled to the app subnet(s) 1126 of the data plane app tier 1146.

The Internet gateway 1134 of the control plane VCN 1116 and of the data plane VCN 1118 can be communicatively coupled to a metadata management service 1152 that can be communicatively coupled to public Internet 1154. Public Internet 1154 can be communicatively coupled to the NAT gateway 1138 of the control plane VCN 1116 and of the data plane VCN 1118. The service gateway 1136 of the control plane VCN 1116 and of the data plane VCN 1118 can be communicatively coupled to cloud services 1156.

In some examples, the service gateway 1136 of the control plane VCN 1116 or of the data plane VCN 1118 can make application programming interface (API) calls to cloud services 1156 without going through public Internet 1154. The API calls to cloud services 1156 from the service gateway 1136 can be one-way: the service gateway 1136 can make API calls to cloud services 1156, and cloud services 1156 can send requested data to the service gateway 1136. But, cloud services 1156 may not initiate API calls to the service gateway 1136.

In some examples, the secure host tenancy 1104 can be directly connected to the service tenancy 1119, which may be otherwise isolated. The secure host subnet 1108 can communicate with the SSH subnet 1114 through an LPG 1110 that may enable two-way communication over an otherwise isolated system. Connecting the secure host subnet 1108 to the SSH subnet 1114 may give the secure host subnet 1108 access to other entities within the service tenancy 1119.

The control plane VCN 1116 may allow users of the service tenancy 1119 to set up or otherwise provision desired resources. Desired resources provisioned in the control plane VCN 1116 may be deployed or otherwise used in the data plane VCN 1118. In some examples, the control plane VCN 1116 can be isolated from the data plane VCN 1118, and the data plane mirror app tier 1140 of the control plane VCN 1116 can communicate with the data plane app tier 1146 of the data plane VCN 1118 via VNICs 1142 that can be contained in the data plane mirror app tier 1140 and the data plane app tier 1146.

In some examples, users of the system, or customers, can make requests, for example create, read, update, or delete (CRUD) operations, through public Internet 1154 that can communicate the requests to the metadata management service 1152. The metadata management service 1152 can communicate the request to the control plane VCN 1116 through the Internet gateway 1134. The request can be received by the LB subnet(s) 1122 contained in the control plane DMZ tier 1120. The LB subnet(s) 1122 may determine that the request is valid, and in response to this determination, the LB subnet(s) 1122 can transmit the request to app subnet(s) 1126 contained in the control plane app tier 1124. If the request is validated and requires a call to public Internet 1154, the call to public Internet 1154 may be transmitted to the NAT gateway 1138 that can make the call to public Internet 1154. Metadata that may be desired to be stored by the request can be stored in the DB subnet(s) 1130.

In some examples, the data plane mirror app tier 1140 can facilitate direct communication between the control plane VCN 1116 and the data plane VCN 1118. For example, changes, updates, or other suitable modifications to configuration may be desired to be applied to the resources contained in the data plane VCN 1118. Via a VNIC 1142, the control plane VCN 1116 can directly communicate with, and can thereby execute the changes, updates, or other suitable modifications to configuration to, resources contained in the data plane VCN 1118.

In some embodiments, the control plane VCN 1116 and the data plane VCN 1118 can be contained in the service tenancy 1119. In this case, the user, or the customer, of the system may not own or operate either the control plane VCN 1116 or the data plane VCN 1118. Instead, the IaaS provider may own or operate the control plane VCN 1116 and the data plane VCN 1118, both of which may be contained in the service tenancy 1119. This embodiment can enable isolation of networks that may prevent users or customers from interacting with other users', or other customers', resources. Also, this embodiment may allow users or customers of the system to store databases privately without needing to rely on public Internet 1154, which may not have a desired level of threat prevention, for storage.

In other embodiments, the LB subnet(s) 1122 contained in the control plane VCN 1116 can be configured to receive a signal from the service gateway 1136. In this embodiment, the control plane VCN 1116 and the data plane VCN 1118 may be configured to be called by a customer of the IaaS provider without calling public Internet 1154. Customers of the IaaS provider may desire this embodiment since database(s) that the customers use may be controlled by the IaaS provider and may be stored on the service tenancy 1119, which may be isolated from public Internet 1154.

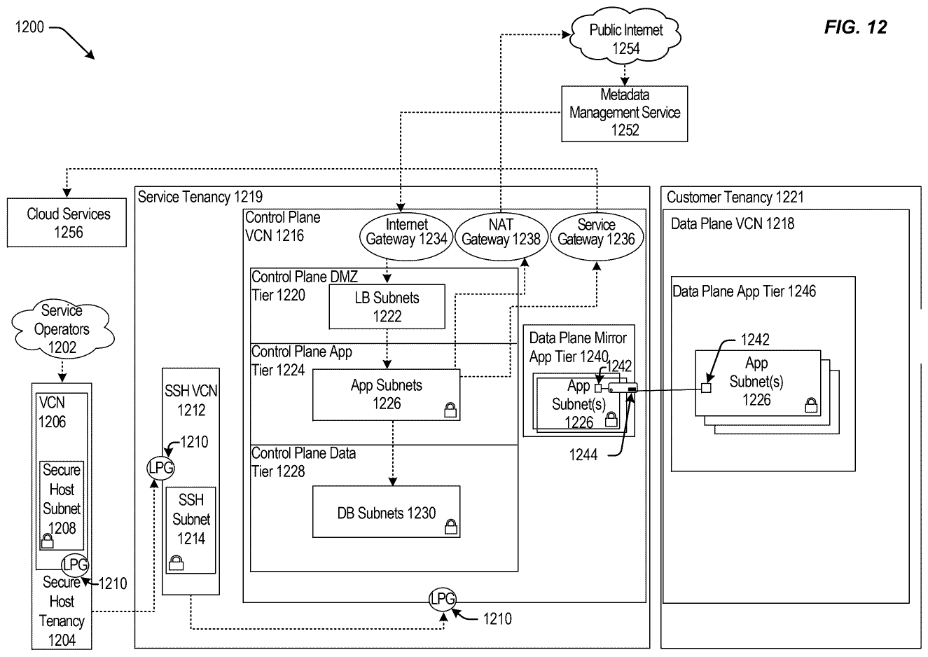

FIG. 12 is a block diagram 1200 illustrating another example pattern of an IaaS architecture, according to at least one embodiment. Service operators 1202 (e.g., service operators 1102 of FIG. 11) can be communicatively coupled to a secure host tenancy 1204 (e.g., the secure host tenancy 1104 of FIG. 11) that can include a virtual cloud network (VCN) 1206 (e.g., the VCN 1106 of FIG. 11) and a secure host subnet 1208 (e.g., the secure host subnet 1108 of FIG. 11). The VCN 1206 can include a local peering gateway (LPG) 1210 (e.g., the LPG 1110 of FIG. 11) that can be communicatively coupled to a secure shell (SSH) VCN 1212 (e.g., the SSH VCN 1112 of FIG. 11) via an LPG 1110 contained in the SSH VCN 1212. The SSH VCN 1212 can include an SSH subnet 1214 (e.g., the SSH subnet 1114 of FIG. 11), and the SSH VCN 1212 can be communicatively coupled to a control plane VCN 1216 (e.g., the control plane VCN 1116 of FIG. 11) via an LPG 1210 contained in the control plane VCN 1216. The control plane VCN 1216 can be contained in a service tenancy 1219 (e.g., the service tenancy 1119 of FIG. 11), and the data plane VCN 1218 (e.g., the data plane VCN 1118 of FIG. 11) can be contained in a customer tenancy 1221 that may be owned or operated by users, or customers, of the system.

The control plane VCN 1216 can include a control plane DMZ tier 1220 (e.g., the control plane DMZ tier 1120 of FIG. 11) that can include LB subnet(s) 1222 (e.g., LB subnet(s) 1122 of FIG. 11), a control plane app tier 1224 (e.g., the control plane app tier 1124 of FIG. 11) that can include app subnet(s) 1226 (e.g., app subnet(s) 1126 of FIG. 11), a control plane data tier 1228 (e.g., the control plane data tier 1128 of FIG. 11) that can include database (DB) subnet(s) 1230 (e.g., similar to DB subnet(s) 1130 of FIG. 11). The LB subnet(s) 1222 contained in the control plane DMZ tier 1220 can be communicatively coupled to the app subnet(s) 1226 contained in the control plane app tier 1224 and an Internet gateway 1234 (e.g., the Internet gateway 1134 of FIG. 11) that can be contained in the control plane VCN 1216, and the app subnet(s) 1226 can be communicatively coupled to the DB subnet(s) 1230 contained in the control plane data tier 1228 and a service gateway 1236 (e.g., the service gateway 1136 of FIG. 11) and a network address translation (NAT) gateway 1238 (e.g., the NAT gateway 1138 of FIG. 11). The control plane VCN 1216 can include the service gateway 1236 and the NAT gateway 1238.

The control plane VCN 1216 can include a data plane mirror app tier 1240 (e.g., the data plane mirror app tier 1140 of FIG. 11) that can include app subnet(s) 1226. The app subnet(s) 1226 contained in the data plane mirror app tier 1240 can include a virtual network interface controller (VNIC) 1242 (e.g., the VNIC of 1142) that can execute a compute instance 1244 (e.g., similar to the compute instance 1144 of FIG. 11). The compute instance 1244 can facilitate communication between the app subnet(s) 1226 of the data plane mirror app tier 1240 and the app subnet(s) 1226 that can be contained in a data plane app tier 1246 (e.g., the data plane app tier 1146 of FIG. 11) via the VNIC 1242 contained in the data plane mirror app tier 1240 and the VNIC 1242 contained in the data plane app tier 1246.

The Internet gateway 1234 contained in the control plane VCN 1216 can be communicatively coupled to a metadata management service 1252 (e.g., the metadata management service 1152 of FIG. 11) that can be communicatively coupled to public Internet 1254 (e.g., public Internet 1154 of FIG. 11). Public Internet 1254 can be communicatively coupled to the NAT gateway 1238 contained in the control plane VCN 1216. The service gateway 1236 contained in the control plane VCN 1216 can be communicatively coupled to cloud services 1256 (e.g., cloud services 1156 of FIG. 11).

In some examples, the data plane VCN 1218 can be contained in the customer tenancy 1221. In this case, the IaaS provider may provide the control plane VCN 1216 for each customer, and the IaaS provider may, for each customer, set up a unique compute instance 1244 that is contained in the service tenancy 1219. Each compute instance 1244 may allow communication between the control plane VCN 1216, contained in the service tenancy 1219, and the data plane VCN 1218 that is contained in the customer tenancy 1221. The compute instance 1244 may allow resources, that are provisioned in the control plane VCN 1216 that is contained in the service tenancy 1219, to be deployed or otherwise used in the data plane VCN 1218 that is contained in the customer tenancy 1221.

In other examples, the customer of the IaaS provider may have databases that live in the customer tenancy 1221. In this example, the control plane VCN 1216 can include the data plane mirror app tier 1240 that can include app subnet(s) 1226. The data plane mirror app tier 1240 can reside in the data plane VCN 1218, but the data plane mirror app tier 1240 may not live in the data plane VCN 1218. That is, the data plane mirror app tier 1240 may have access to the customer tenancy 1221, but the data plane mirror app tier 1240 may not exist in the data plane VCN 1218 or be owned or operated by the customer of the IaaS provider. The data plane mirror app tier 1240 may be configured to make calls to the data plane VCN 1218 but may not be configured to make calls to any entity contained in the control plane VCN 1216. The customer may desire to deploy or otherwise use resources in the data plane VCN 1218 that are provisioned in the control plane VCN 1216, and the data plane mirror app tier 1240 can facilitate the desired deployment, or other usage of resources, of the customer.

In some embodiments, the customer of the IaaS provider can apply filters to the data plane VCN 1218. In this embodiment, the customer can determine what the data plane VCN 1218 can access, and the customer may restrict access to public Internet 1254 from the data plane VCN 1218. The IaaS provider may not be able to apply filters or otherwise control access of the data plane VCN 1218 to any outside networks or databases. Applying filters and controls by the customer onto the data plane VCN 1218, contained in the customer tenancy 1221, can help isolate the data plane VCN 1218 from other customers and from public Internet 1254.

In some embodiments, cloud services 1256 can be called by the service gateway 1236 to access services that may not exist on public Internet 1254, on the control plane VCN 1216, or on the data plane VCN 1218. The connection between cloud services 1256 and the control plane VCN 1216 or the data plane VCN 1218 may not be live or continuous. Cloud services 1256 may exist on a different network owned or operated by the IaaS provider. Cloud services 1256 may be configured to receive calls from the service gateway 1236 and may be configured to not receive calls from public Internet 1254. Some cloud services 1256 may be isolated from other cloud services 1256, and the control plane VCN 1216 may be isolated from cloud services 1256 that may not be in the same region as the control plane VCN 1216. For example, the control plane VCN 1216 may be located in “Region 1,” and cloud service “Deployment 11,” may be located in Region 1 and in “Region 2.” If a call to Deployment 11 is made by the service gateway 1236 contained in the control plane VCN 1216 located in Region 1, the call may be transmitted to Deployment 11 in Region 1. In this example, the control plane VCN 1216, or Deployment 11 in Region 1, may not be communicatively coupled to, or otherwise in communication with, Deployment 11 in Region 2.

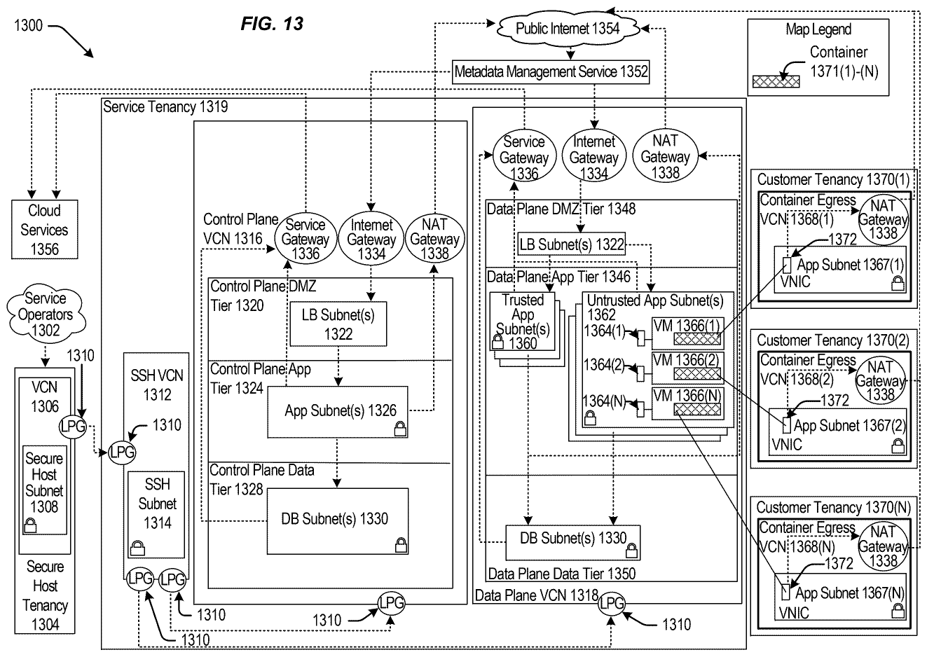

FIG. 13 is a block diagram 1300 illustrating another example pattern of an IaaS architecture, according to at least one embodiment. Service operators 1302 (e.g., service operators 1102 of FIG. 11) can be communicatively coupled to a secure host tenancy 1304 (e.g., the secure host tenancy 1104 of FIG. 11) that can include a virtual cloud network (VCN) 1306 (e.g., the VCN 1106 of FIG. 11) and a secure host subnet 1308 (e.g., the secure host subnet 1108 of FIG. 11). The VCN 1306 can include an LPG 1310 (e.g., the LPG 1110 of FIG. 11) that can be communicatively coupled to an SSH VCN 1312 (e.g., the SSH VCN 1112 of FIG. 11) via an LPG 1310 contained in the SSH VCN 1312. The SSH VCN 1312 can include an SSH subnet 1314 (e.g., the SSH subnet 1114 of FIG. 11), and the SSH VCN 1312 can be communicatively coupled to a control plane VCN 1316 (e.g., the control plane VCN 1116 of FIG. 11) via an LPG 1310 contained in the control plane VCN 1316 and to a data plane VCN 1318 (e.g., the data plane 1118 of FIG. 11) via an LPG 1310 contained in the data plane VCN 1318. The control plane VCN 1316 and the data plane VCN 1318 can be contained in a service tenancy 1319 (e.g., the service tenancy 1119 of FIG. 11).

The control plane VCN 1316 can include a control plane DMZ tier 1320 (e.g., the control plane DMZ tier 1120 of FIG. 11) that can include load balancer (LB) subnet(s) 1322 (e.g., LB subnet(s) 1122 of FIG. 11), a control plane app tier 1324 (e.g., the control plane app tier 1124 of FIG. 11) that can include app subnet(s) 1326 (e.g., similar to app subnet(s) 1126 of FIG. 11), a control plane data tier 1328 (e.g., the control plane data tier 1128 of FIG. 11) that can include DB subnet(s) 1330. The LB subnet(s) 1322 contained in the control plane DMZ tier 1320 can be communicatively coupled to the app subnet(s) 1326 contained in the control plane app tier 1324 and to an Internet gateway 1334 (e.g., the Internet gateway 1134 of FIG. 11) that can be contained in the control plane VCN 1316, and the app subnet(s) 1326 can be communicatively coupled to the DB subnet(s) 1330 contained in the control plane data tier 1328 and to a service gateway 1336 (e.g., the service gateway of FIG. 11) and a network address translation (NAT) gateway 1338 (e.g., the NAT gateway 1138 of FIG. 11). The control plane VCN 1316 can include the service gateway 1336 and the NAT gateway 1338.

The data plane VCN 1318 can include a data plane app tier 1346 (e.g., the data plane app tier 1146 of FIG. 11), a data plane DMZ tier 1348 (e.g., the data plane DMZ tier 1148 of FIG. 11), and a data plane data tier 1350 (e.g., the data plane data tier 1150 of FIG. 11). The data plane DMZ tier 1348 can include LB subnet(s) 1322 that can be communicatively coupled to trusted app subnet(s) 1360 and untrusted app subnet(s) 1362 of the data plane app tier 1346 and the Internet gateway 1334 contained in the data plane VCN 1318. The trusted app subnet(s) 1360 can be communicatively coupled to the service gateway 1336 contained in the data plane VCN 1318, the NAT gateway 1338 contained in the data plane VCN 1318, and DB subnet(s) 1330 contained in the data plane data tier 1350. The untrusted app subnet(s) 1362 can be communicatively coupled to the service gateway 1336 contained in the data plane VCN 1318 and DB subnet(s) 1330 contained in the data plane data tier 1350. The data plane data tier 1350 can include DB subnet(s) 1330 that can be communicatively coupled to the service gateway 1336 contained in the data plane VCN 1318.

The untrusted app subnet(s) 1362 can include one or more primary VNICs 1364(1)-(N) that can be communicatively coupled to tenant virtual machines (VMs) 1366(1)-(N). Each tenant VM 1366(1)-(N) can be communicatively coupled to a respective app subnet 1367(1)-(N) that can be contained in respective container egress VCNs 1368(1)-(N) that can be contained in respective customer tenancies 1370(1)-(N). Respective secondary VNICs 1372(1)-(N) can facilitate communication between the untrusted app subnet(s) 1362 contained in the data plane VCN 1318 and the app subnet contained in the container egress VCNs 1368(1)-(N). Each container egress VCNs 1368(1)-(N) can include a NAT gateway 1338 that can be communicatively coupled to public Internet 1354 (e.g., public Internet 1154 of FIG. 11).

The Internet gateway 1334 contained in the control plane VCN 1316 and contained in the data plane VCN 1318 can be communicatively coupled to a metadata management service 1352 (e.g., the metadata management system 1152 of FIG. 11) that can be communicatively coupled to public Internet 1354. Public Internet 1354 can be communicatively coupled to the NAT gateway 1338 contained in the control plane VCN 1316 and contained in the data plane VCN 1318. The service gateway 1336 contained in the control plane VCN 1316 and contained in the data plane VCN 1318 can be communicatively coupled to cloud services 1356.

In some embodiments, the data plane VCN 1318 can be integrated with customer tenancies 1370. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 1346. Code to run the function may be executed in the VMs 1366(1)-(N), and the code may not be configured to run anywhere else on the data plane VCN 1318. Each VM 1366(1)-(N) may be connected to one customer tenancy 1370. Respective containers 1371(1)-(N) contained in the VMs 1366(1)-(N) may be configured to run the code. In this case, there can be a dual isolation (e.g., the containers 1371(1)-(N) running code, where the containers 1371(1)-(N) may be contained in at least the VM 1366(1)-(N) that are contained in the untrusted app subnet(s) 1362), which may help prevent incorrect or otherwise undesirable code from damaging the network of the IaaS provider or from damaging a network of a different customer. The containers 1371(1)-(N) may be communicatively coupled to the customer tenancy 1370 and may be configured to transmit or receive data from the customer tenancy 1370. The containers 1371(1)-(N) may not be configured to transmit or receive data from any other entity in the data plane VCN 1318. Upon completion of running the code, the IaaS provider may kill or otherwise dispose of the containers 1371(1)-(N).

In some embodiments, the trusted app subnet(s) 1360 may run code that may be owned or operated by the IaaS provider. In this embodiment, the trusted app subnet(s) 1360 may be communicatively coupled to the DB subnet(s) 1330 and be configured to execute CRUD operations in the DB subnet(s) 1330. The untrusted app subnet(s) 1362 may be communicatively coupled to the DB subnet(s) 1330, but in this embodiment, the untrusted app subnet(s) may be configured to execute read operations in the DB subnet(s) 1330. The containers 1371(1)-(N) that can be contained in the VM 1366(1)-(N) of each customer and that may run code from the customer may not be communicatively coupled with the DB subnet(s) 1330.

In other embodiments, the control plane VCN 1316 and the data plane VCN 1318 may not be directly communicatively coupled. In this embodiment, there may be no direct communication between the control plane VCN 1316 and the data plane VCN 1318. However, communication can occur indirectly through at least one method. An LPG 1310 may be established by the IaaS provider that can facilitate communication between the control plane VCN 1316 and the data plane VCN 1318. In another example, the control plane VCN 1316 or the data plane VCN 1318 can make a call to cloud services 1356 via the service gateway 1336. For example, a call to cloud services 1356 from the control plane VCN 1316 can include a request for a service that can communicate with the data plane VCN 1318.

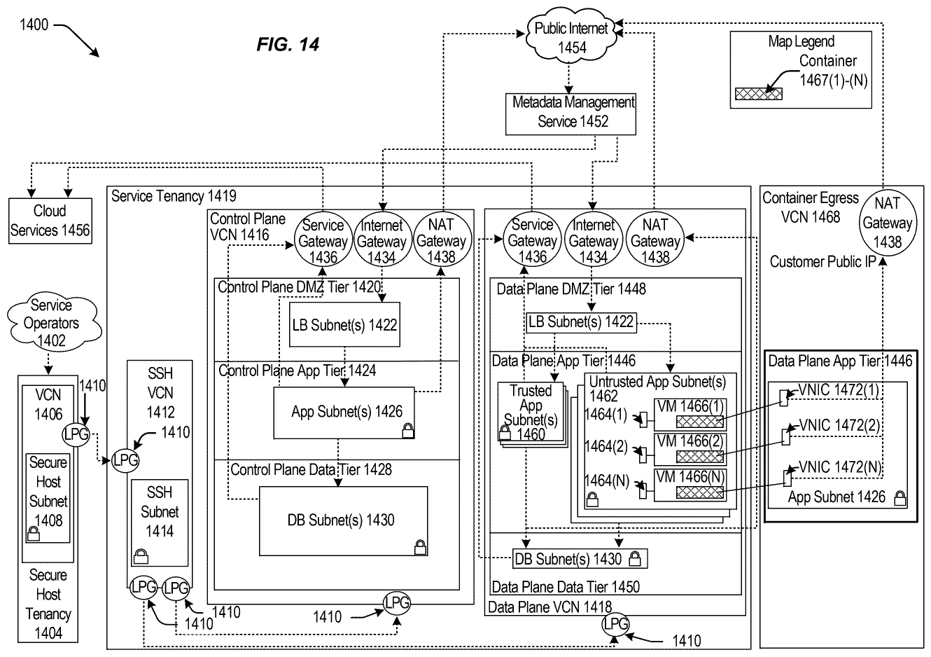

FIG. 14 is a block diagram 1400 illustrating another example pattern of an Iaas architecture, according to at least one embodiment. Service operators 1402 (e.g., service operators 1102 of FIG. 11) can be communicatively coupled to a secure host tenancy 1404 (e.g., the secure host tenancy 1104 of FIG. 11) that can include a virtual cloud network (VCN) 1406 (e.g., the VCN 1106 of FIG. 11) and a secure host subnet 1408 (e.g., the secure host subnet 1108 of FIG. 11). The VCN 1406 can include an LPG 1410 (e.g., the LPG 1110 of FIG. 11) that can be communicatively coupled to an SSH VCN 1412 (e.g., the SSH VCN 1112 of FIG. 11) via an LPG 1410 contained in the SSH VCN 1412. The SSH VCN 1412 can include an SSH subnet 1414 (e.g., the SSH subnet 1114 of FIG. 11), and the SSH VCN 1412 can be communicatively coupled to a control plane VCN 1416 (e.g., the control plane VCN 1116 of FIG. 11) via an LPG 1410 contained in the control plane VCN 1416 and to a data plane VCN 1418 (e.g., the data plane 1118 of FIG. 11) via an LPG 1410 contained in the data plane VCN 1418. The control plane VCN 1416 and the data plane VCN 1418 can be contained in a service tenancy 1419 (e.g., the service tenancy 1119 of FIG. 11).

The control plane VCN 1416 can include a control plane DMZ tier 1420 (e.g., the control plane DMZ tier 1120 of FIG. 11) that can include LB subnet(s) 1422 (e.g., LB subnet(s) 1122 of FIG. 11), a control plane app tier 1424 (e.g., the control plane app tier 1124 of FIG. 11) that can include app subnet(s) 1426 (e.g., app subnet(s) 1126 of FIG. 11), a control plane data tier 1428 (e.g., the control plane data tier 1128 of FIG. 11) that can include DB subnet(s) 1430 (e.g., DB subnet(s) 1330 of FIG. 13). The LB subnet(s) 1422 contained in the control plane DMZ tier 1420 can be communicatively coupled to the app subnet(s) 1426 contained in the control plane app tier 1424 and to an Internet gateway 1434 (e.g., the Internet gateway 1134 of FIG. 11) that can be contained in the control plane VCN 1416, and the app subnet(s) 1426 can be communicatively coupled to the DB subnet(s) 1430 contained in the control plane data tier 1428 and to a service gateway 1436 (e.g., the service gateway of FIG. 11) and a network address translation (NAT) gateway 1438 (e.g., the NAT gateway 1138 of FIG. 11). The control plane VCN 1416 can include the service gateway 1436 and the NAT gateway 1438.

The data plane VCN 1418 can include a data plane app tier 1446 (e.g., the data plane app tier 1146 of FIG. 11), a data plane DMZ tier 1448 (e.g., the data plane DMZ tier 1148 of FIG. 11), and a data plane data tier 1450 (e.g., the data plane data tier 1150 of FIG. 11). The data plane DMZ tier 1448 can include LB subnet(s) 1422 that can be communicatively coupled to trusted app subnet(s) 1460 (e.g., trusted app subnet(s) 1360 of FIG. 13) and untrusted app subnet(s) 1462 (e.g., untrusted app subnet(s) 1362 of FIG. 13) of the data plane app tier 1446 and the Internet gateway 1434 contained in the data plane VCN 1418. The trusted app subnet(s) 1460 can be communicatively coupled to the service gateway 1436 contained in the data plane VCN 1418, the NAT gateway 1438 contained in the data plane VCN 1418, and DB subnet(s) 1430 contained in the data plane data tier 1450. The untrusted app subnet(s) 1462 can be communicatively coupled to the service gateway 1436 contained in the data plane VCN 1418 and DB subnet(s) 1430 contained in the data plane data tier 1450. The data plane data tier 1450 can include DB subnet(s) 1430 that can be communicatively coupled to the service gateway 1436 contained in the data plane VCN 1418.

The untrusted app subnet(s) 1462 can include primary VNICs 1464(1)-(N) that can be communicatively coupled to tenant virtual machines (VMs) 1466(1)-(N) residing within the untrusted app subnet(s) 1462. Each tenant VM 1466(1)-(N) can run code in a respective container 1467(1)-(N), and be communicatively coupled to an app subnet 1426 that can be contained in a data plane app tier 1446 that can be contained in a container egress VCN 1468. Respective secondary VNICs 1472(1)-(N) can facilitate communication between the untrusted app subnet(s) 1462 contained in the data plane VCN 1418 and the app subnet contained in the container egress VCN 1468. The container egress VCN can include a NAT gateway 1438 that can be communicatively coupled to public Internet 1454 (e.g., public Internet 1154 of FIG. 11).

The Internet gateway 1434 contained in the control plane VCN 1416 and contained in the data plane VCN 1418 can be communicatively coupled to a metadata management service 1452 (e.g., the metadata management system 1152 of FIG. 11) that can be communicatively coupled to public Internet 1454. Public Internet 1454 can be communicatively coupled to the NAT gateway 1438 contained in the control plane VCN 1416 and contained in the data plane VCN 1418. The service gateway 1436 contained in the control plane VCN 1416 and contained in the data plane VCN 1418 can be communicatively coupled to cloud services 1456.

In some examples, the pattern illustrated by the architecture of block diagram 1400 of FIG. 14 may be considered an exception to the pattern illustrated by the architecture of block diagram 1300 of FIG. 13 and may be desirable for a customer of the IaaS provider if the IaaS provider cannot directly communicate with the customer (e.g., a disconnected region). The respective containers 1467(1)-(N) that are contained in the VMs 1466(1)-(N) for each customer can be accessed in real-time by the customer. The containers 1467(1)-(N) may be configured to make calls to respective secondary VNICs 1472(1)-(N) contained in app subnet(s) 1426 of the data plane app tier 1446 that can be contained in the container egress VCN 1468. The secondary VNICs 1472(1)-(N) can transmit the calls to the NAT gateway 1438 that may transmit the calls to public Internet 1454. In this example, the containers 1467(1)-(N) that can be accessed in real-time by the customer can be isolated from the control plane VCN 1416 and can be isolated from other entities contained in the data plane VCN 1418. The containers 1467(1)-(N) may also be isolated from resources from other customers.

In other examples, the customer can use the containers 1467(1)-(N) to call cloud services 1456. In this example, the customer may run code in the containers 1467(1)-(N) that requests a service from cloud services 1456. The containers 1467(1)-(N) can transmit this request to the secondary VNICs 1472(1)-(N) that can transmit the request to the NAT gateway that can transmit the request to public Internet 1454. Public Internet 1454 can transmit the request to LB subnet(s) 1422 contained in the control plane VCN 1416 via the Internet gateway 1434. In response to determining the request is valid, the LB subnet(s) can transmit the request to app subnet(s) 1426 that can transmit the request to cloud services 1456 via the service gateway 1436.

It should be appreciated that IaaS architectures 1100, 1200, 1300, 1400 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

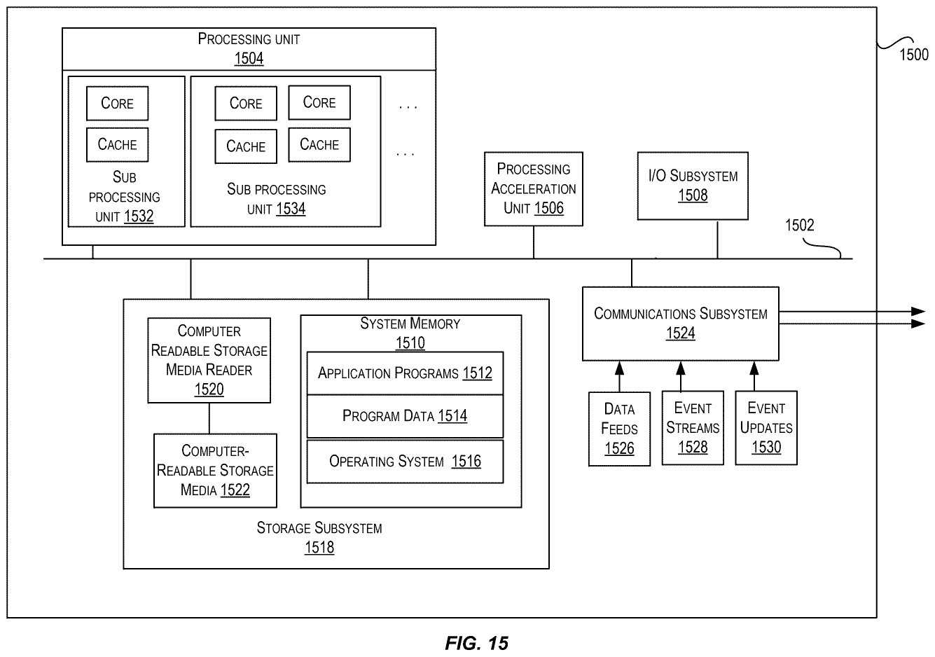

FIG. 15 illustrates an example computer system 1500, in which various embodiments may be implemented. The system 1500 may be used to implement any of the computer systems described above. As shown in the figure, computer system 1500 includes a processing unit 1504 that communicates with a number of peripheral subsystems via a bus subsystem 1502. These peripheral subsystems may include a processing acceleration unit 1506, an I/O subsystem 1508, a storage subsystem 1518 and a communications subsystem 1524. Storage subsystem 1518 includes tangible computer-readable storage media 1522 and a system memory 1510.

Bus subsystem 1502 provides a mechanism for letting the various components and subsystems of computer system 1500 communicate with each other as intended. Although bus subsystem 1502 is shown schematically as a single bus, alternative embodiments of the bus subsystem may utilize multiple buses. Bus subsystem 1502 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1504, which can be implemented as one or more integrated circuits (e.g., a conventional microprocessor or microcontroller), controls the operation of computer system 1500. One or more processors may be included in processing unit 1504. These processors may include single core or multicore processors. In certain embodiments, processing unit 1504 may be implemented as one or more independent processing units 1532 and/or 1534 with single or multicore processors included in each processing unit. In other embodiments, processing unit 1504 may also be implemented as a quad-core processing unit formed by integrating two dual-core processors into a single chip.

In various embodiments, processing unit 1504 can execute a variety of programs in response to program code and can maintain multiple concurrently executing programs or processes. At any given time, some or all of the program code to be executed can be resident in processor(s) 1504 and/or in storage subsystem 1518. Through suitable programming, processor(s) 1504 can provide various functionalities described above. Computer system 1500 may additionally include a processing acceleration unit 1506, which can include a digital signal processor (DSP), a special-purpose processor, and/or the like.

I/O subsystem 1508 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1500 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1500 may comprise a storage subsystem 1518 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1504 provide the functionality described above. Storage subsystem 1518 may also provide a repository for storing data used in accordance with the present disclosure.

As depicted in the example in FIG. 15, storage subsystem 1518 can include various components including a system memory 1510, computer-readable storage media 1522, and a computer readable storage media reader 1520. System memory 1510 may store program instructions that are loadable and executable by processing unit 1504. System memory 1510 may also store data that is used during the execution of the instructions and/or data that is generated during the execution of the program instructions. Various different kinds of programs may be loaded into system memory 1510 including but not limited to client applications, Web browsers, mid-tier applications, relational database management systems (RDBMS), virtual machines, containers, etc.

System memory 1510 may also store an operating system 1516. Examples of operating system 1516 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1500 executes one or more virtual machines, the virtual machines along with their guest operating systems (GOSs) may be loaded into system memory 1510 and executed by one or more processors or cores of processing unit 1504.

System memory 1510 can come in different configurations depending upon the type of computer system 1500. For example, system memory 1510 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1510 may include a basic input/output system (BIOS) containing basic routines that help to transfer information between elements within computer system 1500, such as during start-up.

Computer-readable storage media 1522 may represent remote, local, fixed, and/or removable storage devices plus storage media for temporarily and/or more permanently containing, storing, computer-readable information for use by computer system 1500 including instructions executable by processing unit 1504 of computer system 1500.

Computer-readable storage media 1522 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1522 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1522 may include, but is not limited to, Zip® drives, flash memory cards, universal serial bus (USB) flash drives, secure digital (SD) cards, DVD disks, digital video tape, and the like. Computer-readable storage media 1522 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1500.

Machine-readable instructions executable by one or more processors or cores of processing unit 1504 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1524 provides an interface to other computer systems and networks. Communications subsystem 1524 serves as an interface for receiving data from and transmitting data to other systems from computer system 1500. For example, communications subsystem 1524 may enable computer system 1500 to connect to one or more devices via the Internet. In some embodiments communications subsystem 1524 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 1524 can provide wired network connectivity (e.g., Ethernet) in addition to or instead of a wireless interface.

In some embodiments, communications subsystem 1524 may also receive input communication in the form of structured and/or unstructured data feeds 1526, event streams 1528, event updates 1530, and the like on behalf of one or more users who may use computer system 1500.

By way of example, communications subsystem 1524 may be configured to receive data feeds 1526 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1524 may also be configured to receive data in the form of continuous data streams, which may include event streams 1528 of real-time events and/or event updates 1530, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1524 may also be configured to output the structured and/or unstructured data feeds 1526, event streams 1528, event updates 1530, and the like to one or more databases that may be in communication with one or more streaming data source computers coupled to computer system 1500.

Computer system 1500 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1500 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A computer-implemented method comprising:
identifying a subset of rejected examples from a set of training examples, wherein the subset of rejected examples include logical form queries that fail one or more tests;
grouping the subset of rejected examples into one or more groups of rejected examples based on similarity between the subset of rejected examples;
augmenting a baseline prompt to include instructions associated with errors in at least some rejected examples in the subset of rejected examples, wherein the augmenting is an iterative process comprising:
generating, by a first generative model, instructions for a group of the one or more groups of rejected examples based on a pattern of error identified for the group of rejected examples,
evaluating performance of a second generative model using the baseline prompt updated to include the instructions and the logical form query generated for each example of: the set of training examples, the subset of rejected examples, or the group of rejected examples, and
in response to the performance meeting or exceeding a threshold, updating the baseline prompt to include the instructions for the group of rejected examples, identifying another subset of rejected examples from the set of training examples or the subset of rejected examples, grouping the another subset of rejected examples into another one or more groups of rejected examples, and repeating the iterative process using the baseline prompt augmented with the instructions from one or more prior cycles of the iterative process and the another one or more groups of rejected examples; and
providing the augmented baseline prompt.

2. The computer-implemented method of claim 1, further comprising:
accessing the set of training examples, wherein each example of the set of training examples includes a natural language utterance;
generating, by the second generative model based on the baseline prompt, a logical form query that corresponds to the natural language utterance for each example of the set of training examples; and
evaluating performance of the second generative model using the logical form query generated for each example of the set of training examples, wherein the identifying of the subset of rejected examples is performed based on the evaluating, and wherein the one or more tests include determining: (i) the logical form queries are not equivalent to corresponding gold queries, (ii) the logical form queries are not able to be executed on a database, (iii) query results from executing the logical form queries on the database are not equivalent to gold query results from executing the corresponding gold queries on the database, or (iv) any combination thereof.

3. The computer-implemented method of claim 1, wherein the iterative process further comprises in response to the performance not meeting or exceeding the threshold, revising the instructions for the group of rejected examples or the another group of rejected examples until the performance meets or exceeds the threshold using the revised instructions or a predetermined number of iterations is met.

4. The computer-implemented method of claim 1, wherein grouping the subset of rejected examples comprises grouping based on a similarity between embedding vectors for each example of the subset of rejected examples.

5. The computer-implemented method of claim 1, further comprising:
receiving, from a client device, a production natural language utterance, wherein the production natural language utterance includes a data request associated with a production database;
generating a prompt based on the production natural language utterance and the updated baseline prompt which includes the instructions;
generating, by a production generative model or the second generative model, a logical form query associated with the production natural language utterance;
executing the logical form query associated with the production natural language utterance on the production database to obtain a production query result; and
providing the production query result to the client device.

6. The computer-implemented method of claim 1, further comprising:
generating a prompt comprising the instructions after the iterative process has completed or after one or more cycles of the iterative process has completed;
generating, by a third generative model, compressed instructions based on the instruction; and
updating the baseline prompt to include the compressed instructions.

7. The computer-implemented method of claim 1, wherein the evaluating comprises:
determining, by one or more generative models, equivalence between the logical form query and a gold logical form query for each example of: the set of training examples, the subset of rejected examples, or the group of rejected examples; or
executing the logical form query and a gold logical form query for each example of: the set of training examples, the subset of rejected examples, or the group of rejected examples on a database, and determining, for each example, whether the logical form query is not executable on the database or when the logical form query is executable on the database, equivalence between a query result obtained via executing the logical form query and a gold query result obtained via executing the gold logical form query,
wherein the evaluating is performed using bootstrap sampling such that the logical form query is randomly selected from the examples for the evaluating.

8. A system comprising:
one or more processors; and
one or more computer-readable media storing instructions which, when executed by the one or more processors, cause the system to perform operations comprising:
identifying a subset of rejected examples from a set of training examples, wherein the subset of rejected examples include logical form queries that fail one or more tests;
grouping the subset of rejected examples into one or more groups of rejected examples based on similarity between the subset of rejected examples;
augmenting a baseline prompt to include instructions associated with errors in at least some rejected examples in the subset of rejected examples, wherein the augmenting is an iterative process comprising:
generating, by a first generative model, instructions for a group of the one or more groups of rejected examples based on a pattern of error identified for the group of rejected examples,
updating the baseline prompt to include the instructions for the group of rejected examples,
generating, by a second generative model based on the updated baseline prompt, a logical form query that corresponds to the natural language utterance for each example of: the set of training examples, the subset of rejected examples, or the group of rejected examples,
evaluating performance of the second generative model using the logical form query generated for each example, and
in response to the performance meeting or exceeding a threshold, updating the baseline prompt to include the instructions for the group of rejected examples, identifying another subset of rejected examples from the set of training examples or the subset of rejected examples, grouping the another subset of rejected examples into another one or more groups of rejected examples, and repeating the iterative process using the baseline prompt augmented with the instructions from one or more prior cycles of the iterative process and the another one or more groups of rejected examples; and
providing the augmented baseline prompt.

9. The system of claim 8, wherein the operations further comprise:
accessing the set of training examples, wherein each example of the set of training examples includes a natural language utterance;
generating, by the second generative model based on the baseline prompt, a logical form query that corresponds to the natural language utterance for each example of the set of training examples; and
evaluating performance of the second generative model using the logical form query generated for each example of the set of training examples, wherein the identifying of the subset of rejected examples is performed based on the evaluating, and wherein the one or more tests include determining: (i) the logical form queries are not equivalent to corresponding gold queries, (ii) the logical form queries are not able to be executed on a database, (iii) query results from executing the logical form queries on the database are not equivalent to gold query results from executing the corresponding gold queries on the database, or (iv) any combination thereof.

10. The system of claim 8, wherein the iterative process further comprises in response to the performance not meeting or exceeding the threshold, revising the instructions for the group of rejected examples or the another group of rejected examples until the performance meets or exceeds the threshold using the revised instructions or a predetermined number of iterations is met.

11. The system of claim 8, wherein grouping the subset of rejected examples comprises grouping based on a similarity between embedding vectors for each example of the subset of rejected examples.

12. The system of claim 8, wherein the operations further comprise:
receiving, from a client device, a production natural language utterance, wherein the production natural language utterance includes a data request associated with a production database;
generating a prompt based on the production natural language utterance and the updated baseline prompt which includes the instructions;
generating, by a production generative model or the second generative model, a logical form query associated with the production natural language utterance;
executing the logical form query associated with the production natural language utterance on the production database to obtain a production query result; and
providing the production query result to the client device.

13. The system of claim 8, wherein the operations further comprise:
generating a prompt comprising the instructions after the iterative process has completed or after one or more cycles of the iterative process has completed;
generating, by a third generative model, compressed instructions based on the instruction; and
updating the baseline prompt to include the compressed instructions.

14. The system of claim 8, wherein the evaluating comprises:
determining, by one or more generative models, equivalence between the logical form query and a gold logical form query for each example of: the set of training examples, the subset of rejected examples, or the group of rejected examples; or
executing the logical form query and a gold logical form query for each example of: the set of training examples, the subset of rejected examples, or the group of rejected examples on a database, and determining, for each example, whether the logical form query is not executable on the database or when the logical form query is executable on the database, equivalence between a query result obtained via executing the logical form query and a gold query result obtained via executing the gold logical form query,
wherein the evaluating is performed using bootstrap sampling such that the logical form query is randomly selected from the examples for the evaluating.

15. One or more non-transitory computer-readable media storing instructions which, when executed by one or more processors, cause the one or more processors to perform operations comprising:
identifying a subset of rejected examples from a set of training examples, wherein the subset of rejected examples include logical form queries that fail one or more tests;
grouping the subset of rejected examples into one or more groups of rejected examples based on similarity between the subset of rejected examples;
augmenting a baseline prompt to include instructions associated with errors in at least some rejected examples in the subset of rejected examples, wherein the augmenting is an iterative process comprising:
generating, by a first generative model, instructions for a group of the one or more groups of rejected examples based on a pattern of error identified for the group of rejected examples,
evaluating performance of a second generative model using the baseline prompt updated to include the instructions and the logical form query generated for each example of: the set of training examples, the subset of rejected examples, or the group of rejected examples,
in response to the performance meeting or exceeding a threshold, updating the baseline prompt to include the instructions for the group of rejected examples, identifying another subset of rejected examples from the set of training examples or the subset of rejected examples, grouping the another subset of rejected examples into another one or more groups of rejected examples, and repeating the iterative process using the baseline prompt augmented with the instructions from one or more prior cycles of the iterative process and the another one or more groups of rejected examples, and
in response to the performance not meeting or exceeding the threshold, revising the instructions for the group of rejected examples or the another group of rejected examples until the performance meets or exceeds the threshold using the revised instructions or a predetermined number of iterations is met; and
providing the augmented baseline prompt.

16. The one or more non-transitory computer-readable media of claim 15, wherein the operations further comprise:
accessing the set of training examples, wherein each example of the set of training examples includes a natural language utterance;
generating, by the second generative model based on the baseline prompt, a logical form query that corresponds to the natural language utterance for each example of the set of training examples; and
evaluating performance of the second generative model using the logical form query generated for each example of the set of training examples, wherein the identifying of the subset of rejected examples is performed based on the evaluating, and wherein the one or more tests include determining: (i) the logical form queries are not equivalent to corresponding gold queries, (ii) the logical form queries are not able to be executed on a database, (iii) query results from executing the logical form queries on the database are not equivalent to gold query results from executing the corresponding gold queries on the database, or (iv) any combination thereof.

17. The one or more non-transitory computer-readable media of claim 15, wherein grouping the subset of rejected examples comprises grouping based on a similarity between embedding vectors for each example of the subset of rejected examples.

18. The one or more non-transitory computer-readable media of claim 15, wherein the operations further comprise:
receiving, from a client device, a production natural language utterance, wherein the production natural language utterance includes a data request associated with a production database;
generating a prompt based on the production natural language utterance and the updated baseline prompt which includes the instructions;
generating, by a production generative model or the second generative model, a logical form query associated with the production natural language utterance;
executing the logical form query associated with the production natural language utterance on the production database to obtain a production query result; and
providing the production query result to the client device.

19. The one or more non-transitory computer-readable media of claim 15, wherein the operations further comprise:
generating a prompt comprising the instructions after the iterative process has completed or after one or more cycles of the iterative process has completed;
generating, by a third generative model, compressed instructions based on the instruction; and
updating the baseline prompt to include the compressed instructions.

20. The one or more non-transitory computer-readable media of claim 15, wherein the evaluating comprises:
determining, by one or more generative models, equivalence between the logical form query and a gold logical form query for each example of: the set of training examples, the subset of rejected examples, or the group of rejected examples; or
executing the logical form query and a gold logical form query for each example of: the set of training examples, the subset of rejected examples, or the group of rejected examples on a database, and determining, for each example, whether the logical form query is not executable on the database or when the logical form query is executable on the database, equivalence between a query result obtained via executing the logical form query and a gold query result obtained via executing the gold logical form query,
wherein the evaluating is performed using bootstrap sampling such that the logical form query is randomly selected from the examples for the evaluating.
